(19) United States
(12) Patent Application Publication
(10) Pub. No.: US 2025/0101211 A1
(43) Pub. Date: Mar. 27, 2025

(54) POLYETHYLENE COMPOSITIONS

(71) Applicant: Dow Global Technologies LLC, Midland, MI (US)

(72) Inventors: Sanjib Biswas, Houston, TX (US); Carol Tsai, Lake Jackson, TX (US); Douglas S. Ginger, Houston, TX (US); Johnathan E. DeLorbe, Lake Jackson, TX (US); Philip P. Fontaine, Pearland, TX (US)

(73) Assignee: Dow Global Technologies LLC, Midland, MI (US)

(21) Appl. No.: 18/728,241

(22) PCT Filed: Jan. 13, 2022
(86) PCT No.: PCT/US2022/012248

§ 371 Date: Jul. 11, 2024

(51) Int. Cl. C08L 23/0807; C08F 2/00; C08F 210/16

(52) U.S. Cl. CPC C08L 23/0815; C08F 2/001; C08F 210/16; C08F 2400/02; C08L 2205/025

(57) ABSTRACT

According to one or more embodiments, a polyethylene composition, which may include a first polyethylene fraction area defined by an area in an elution profile via iCCD analysis method in a temperature range of 45° C. to 90° C.; a first peak in the temperature range of 45° C. to 90° C. in the elution profile; a second polyethylene fraction area defined by an area in the elution profile in a temperature range of 90° C. to 120° C.; a second peak in the temperature range of 90° C. to 120° C. in the elution profile; and a local minimum in a temperature range of from 80 C to 95° C. in the elution profile. The polyethylene composition may have a density of 0.924 g/cm³ to 0.936 g/cm³ and a melt index (I₂) of 0.5 g/10 minutes to 1.2 g/10 minutes. A ratio of the first polyethylene fraction area to the second polyethylene fraction area may be 2.0 to 4.0.

### FIELD

Embodiments described herein generally relate to polymer compositions and more specifically relate to polyethylene compositions.

### BACKGROUND

The use of polyolefin compositions in the formation of articles is generally known. Any conventional method may be employed to produce such polyolefin compositions. Various polymerization techniques using different catalyst systems have been employed to produce such polyolefin compositions suitable for the formation of articles, such as films.

### SUMMARY

Various polymerization techniques using different catalyst systems have been employed to produce such polyolefin compositions suitable for the formation of articles, such as films, which may be used in packaging applications.

However, despite the research efforts in developing compositions suitable for the formation of articles, there is still a need for compositions having a balance of stiffness and performance properties that meet customer and industry requirements. Moreover, researchers continually seek solutions to allow for the reduction of material costs, such as, from down-gauging (i.e., using thinner film thicknesses) or by reducing or eliminating relatively expensive materials. Accordingly, there are needs for compositions having a balance of balance of stiffness and performance properties that meet customer and industry requirements.

Embodiments of the present disclosure are directed to polyethylene compositions that may exhibit desirable stiffness while maintaining desirable performance properties. For example, when used in films, the presently disclosed polyethylene compositions may exhibit desirable stiffness while maintaining desirable dart impact strength. As such, embodiments of the present disclosure may provide a polyethylene composition that, when utilized in the production of polymeric articles, may allow for reduced material costs resulting from said balance of stiffness and dart impact strength.

According to one or more embodiments, a polyethylene composition is provided. The polyethylene composition may include a first polyethylene fraction area defined by an area in an elution profile via improved comonomer composition distribution (iCCD) analysis method in a temperature range of 45° C. to 90° C.; a first peak in the temperature range of 45° C. to 90° C. in the elution profile; a second polyethylene fraction area defined by an area in the elution profile in a temperature range of 90° C. to 120° C.; a second peak in the temperature range of 90° C. to 120° C. in the elution profile; and a local minimum in a temperature range of from 80° C. to 95° C. in the elution profile. The polyethylene composition may have a density of from 0.924 g/cm³ to 0.936 g/cm³ and a melt index (I₂) of from 0.5 g/10 minutes to 1.2 g/10 minutes. A ratio of the first polyethylene fraction area to the second polyethylene fraction area may be from 2.0 to 4.0.

These and embodiments are described in more detail in the following Detailed Description in conjunction with the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts an iCCD elution profile, according to one or more embodiments presently described; and

FIG. 2 schematically depicts a reactor system useful for producing polyethylene, according to one or more embodiments presently described.

### DETAILED DESCRIPTION

Described herein are embodiments of polyethylene compositions. Such polyethylene compositions can be used, for example, in packaging applications. The polyethylene compositions may include a first polyethylene fraction and a second polyethylene fraction. The polyethylene composition may be included in a film (including monolayer films and multilayer films) and other articles, such as multilayer structures and packages. Conventional polyethylene materials, when utilized in articles such as films, a tradeoff between tear strength (sometimes correlated with overall density) and dart strength is often observed. For example, higher densities may provide higher tear strength, but may result in reduced dart strength. However, both good tear strength and dart strength are desirable in a number of end uses and products made from polyethylene. Embodiments of the presently described polyethylene compositions may provide for a good dart strength at relatively high densities, providing for a good balance of toughness along with good tear strength.

Unless stated to the contrary, implicit from the context, or customary in the art, all parts and percent values are based on weight, all temperatures are in ° C., and all test methods are current as of the filing date of this disclosure.

As described herein, a “polyethylene” or “ethylene-based polymer” refers to polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE). These polyethylene materials are generally known in the art; however, the following descriptions may be helpful in understanding the differences between some of these different polyethylene resins.

The term “composition,” as used herein, refers to a mixture of materials which comprises the composition, as well as reaction products and decomposition products formed from the materials of the composition.

The term “LDPE” may also be referred to as “high pressure ethylene polymer” or “highly branched polyethylene” and may be defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy), and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. Nos. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.924 g/cm³ to 0.936 g/cm³. “MDPE” is typically made using chromium or Ziegler-Natta catalysts or using single-site catalysts including, but not limited to, substituted mono- or bis-cyclopentadienyl catalysts (typically referred to as metallocene), constrained geometry catalysts, phosphinimine catalysts and polyvalent aryloxyether catalysts (typically referred to as bisphenyl phenoxy).

The term “HDPE” refers to polyethylenes having densities greater than about 0.936 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers. Polyethylene (ethylene-based) elastomers or plastomers generally have densities of 0.855 to 0.912 g/cm³.

“Blend,” “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those skilled in the art.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

### Polyethylene Composition and Characterization

In one or more embodiments, the polyethylene composition may have a density of 0.924 g/cm³ to 0.936 g/cm³. For example, embodiments of the presently-disclosed polyethylene compositions may have densities of from 0.924 g/cm³ to 0.934 g/cm³, from 0.924 g/cm³ to 0.932 g/cm³, from 0.924 g/cm³ to 0.930 g/cm³, from 0.924 g/cm³ to 0.928 g/cm³, from 0.924 g/cm³ to 0.926 g/cm³, from 0.926 g/cm³ to 0.936 g/cm³, from 0.926 g/cm³ to 0.934 g/cm³, from 0.926 g/cm³ to 0.932 g/cm³, from 0.926 g/cm³ to 0.930 g/cm³, from 0.926 g/cm³ to 0.928 g/cm³, from 0.928 g/cm³ to 0.936 g/cm³, from 0.928 g/cm³ to 0.934 g/cm³, from 0.928 g/cm³ to 0.932 g/cm³, from 0.928 g/cm³ to 0.930 g/cm³, from 0.930 g/cm³ to 0.936 g/cm³, from 0.930 g/cm³ to 0.934 g/cm³, from 0.930 g/cm³ to 0.932 g/cm³, from 0.932 g/cm³ to 0.936 g/cm³, from 0.932 g/cm³ to 0.934 g/cm³, from 0.934 g/cm³ to 0.936 g/cm³, or any combination of these ranges.

In one or more embodiments, the polyethylene composition may have a melt index (I₂) of 0.50 g/10 minutes to 1.2 g/10 minutes. For example, in one or more embodiments, the polyethylene composition may have a melt index (I₂) of from 0.5 g/10 minutes to 1.0 g/10 minutes, from 0.5 g/10 minutes to 0.8 g/10 minutes, from 0.5 g/10 minutes to 0.6 g/10 minutes, from 0.6 g/10 minutes to 1.2 g/10 minutes, from 0.6 g/10 minutes to 1.0 g/10 minutes, from 0.6 g/10 minutes to 0.8 g/10 minutes, from 0.8 g/10 minutes to 1.2 g/10 minutes, from 0.8 g/10 minutes to 1.0 g/10 minutes, from 1.0 g/10 minutes to 1.2 g/10 minutes, or any combination of these ranges.

According to one or more additional embodiments, the polyethylene composition may have a zero shear viscosity ratio of less than 3.0. For example, the polyethylene composition may have a zero shear viscosity ratio of less than 2.9, less than 2.8, less than 2.7, less than 2.6, less than 2.5, less than 2.4, less than 2.3, less than 2.2, less than 2.1, less than 2.0, less than 1.9, less than 1.8, less than 1.7, less than 1.6, less than 1.5, less than 1.4, less than 1.3, less than 1.2, or even less than 1.1. In one or more embodiments, the polyethylene composition may have a zero shear viscosity ratio of at least 1.0.

According to embodiments, the polyethylene compositions may have a molecular weight distribution, expressed as the ratio of the weight average molecular weight to number average molecular weight (Mw/Mn), in the range of from 2.5 to 8.0. For example, the polyethylene composition may have a molecular weight distribution of from 2.5 to 7.0, from 2.5 to 6.0, from 2.5 to 5.0, from 2.5 to 4.0, from 2.5 to 3.0, from 3.0 to 8.0, from 3.0 to 7.0, from 3.0 to 6.0, from 3.0 to 5.0, from 3.0 to 4.0, from 4.0 to 8.0, from 4.0 to 7.0, from 4.0 to 6.0, from 4.0 to 5.0, from 5.0 to 8.0, from 5.0 to 7.0, from 5.0 to 6.0, from 6.0 to 8.0, from 6.0 to 7.0, or from 7.0 to 8.0, or any combination of these ranges. In additional embodiments, the polyethylene composition may have a molecular weight distribution of from 3.0 to 5.0. As presently described, the molecular weight distribution may be calculated according to gel permeation chromatography (GPC) techniques as described herein.

As described herein, a polyethylene “fraction” refers to a portion of the total composition of the multimodal polyethylene composition. The presently-disclosed embodiments include at least a “first polyethylene fraction” and a “second polyethylene fraction.” The various fractions included in the polyethylene composition may be quantified by their temperature range in an elution profile via improved comonomers composition distribution (iCCD) analysis method. Unless specified, any elution profile referred to herein is the elution profile observed via iCCD. Examples of such fractions will be better understood in view of the examples provided herewith. In general, the first fraction may include a peak in the temperature range of the first fraction and the second fraction may include a peak in the temperature range of the second fraction. The polyethylene compositions described herein may be referred to as “multimodal,” meaning that they include at least two peaks in their elution profile. Some embodiments may be “bimodal,” meaning that two major peaks are present.

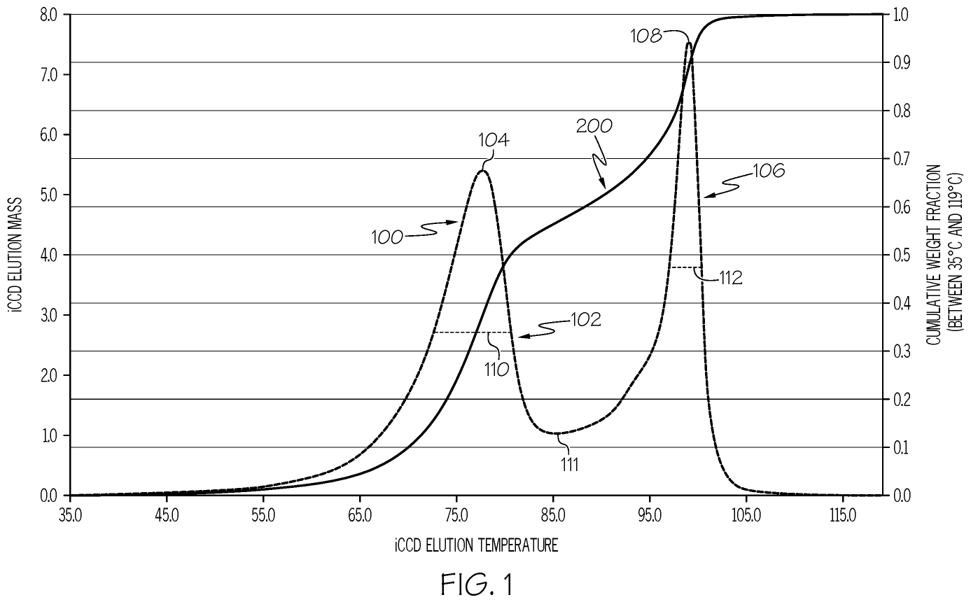

In reference to the described iCCD distribution, FIG. 1 schematically depicts a sample iCCD distribution 100 along with the cumulative weight fraction curve 200. FIG. 1 depicts, generally, several features of the iCCD profiles of the presently described polyethylene compositions, such as the first fraction, the second fraction, the half peak widths, etc., which are discussed in detail herein. As such, FIG. 1 can be used as a reference with respect to the disclosures related the iCCD profile provided herein. Specifically, the first fraction 102 and second fraction 106 are depicted. The first fraction 102 has a peak 104 and the second fraction 106 has a peak 108. Each fraction has a half peak width 110 and 112. There is a local minimum 111 between the peak 104 and the peak 108. It should be understood that the profile of FIG. 1 is not derived from experimentation or observation but is instead supplied for informational purposes of describing particular features of an iCCD elution profile.

In one or more embodiments, the polyethylene composition may have a first polyethylene fraction area defined by an area in the elution profile via improved comonomer composition distribution (iCCD) analysis method in a temperature range of 45° C. to 90° C. The first polyethylene area fraction may correspond with the total relative mass of the polymer fraction in the polyethylene composition, which may be referred to herein as the “first mass fraction.”

In embodiments, the first polyethylene fraction may have at least one peak in a temperature range of 45° C. and 90° C. in an elution profile via iCCD. In some embodiments, the first polyethylene fraction area may encompass the area in the elution profile beneath the peak in the temperature range of 45° C. and 90° C. in the elution profile via iCCD. In further embodiments, the first polyethylene fraction may have a single peak in a temperature range of 45° C. and 90° C. in an elution profile via iCCD. As used herein, a “single peak” refers to an iCCD wherein a particular fraction include only one peak. That is, in some embodiments, the iCCD of the first polyethylene fraction includes only an upward sloping region followed by a downward sloping region to form the single peak. In one or more embodiments, the single peak of the first polyethylene fraction may be in a temperature range of from 45° C. and 90° C., such as from 45° C. and 85° C. and from 45° C. and 80° C.

It should be understood that a peak in the first polyethylene fraction may not be formed by a local minimum in the respective polyethylene fraction at a defined temperature boundary. That is, the peak must be a peak in the context of the entire spectrum, not a peak formed by the threshold temperature of a polyethylene fraction. For example, if a single peak followed by a single valley were present in a polyethylene fraction (an upward slope followed by a downward slope followed by an upward slope), only a single peak would be present in such a polyethylene fraction.

In one or more embodiments, the first polyethylene fraction area may comprise greater than 50% of the total area of the elution profile (for example, greater than 55% or greater than 60% of the total area of the elution profile). For example, the first polyethylene fraction area may comprise from 50% to 90% of the total area of the elution profile, such as from 50% to 80%, from 50% to 70%, from 50% to 60%, from 60% to 90%, from 60% to 80%, from 60% to 70%, from 70%, to 90%, from 70% to 80%, from 80% to 90% of the total area of the elution profile.

In one or more embodiments, the polyethylene composition may have a second polyethylene fraction area in the temperature range from 90° C. to 120° C. of an elution profile via improved comonomer composition distribution (iCCD) analysis method. As used herein, the second polyethylene fraction area may be defined as the area in the elution profile beneath the second polyethylene fraction between 90° C. and 120° C. The second polyethylene area fraction may correspond with the total relative mass of the polymer fraction in the polyethylene composition, referred to herein as the “second mass fraction.”

In one or more embodiments, the second polyethylene fraction may have a single peak in the temperature range of 90° C. to 120° C. in the elution profile via iCCD. It should be understood that a peak in the second polyethylene fraction may not be formed by a local minimum in the respective polyethylene fraction at a defined temperature boundary. That is, the peak must be a peak in the context of the entire spectrum, not a peak formed by the threshold temperature of a polyethylene fraction. For example, if a single peak followed by a single valley were present in a polyethylene fraction (an upward slope followed by a downward slope followed by an upward slope), only a single peak would be present in such a polyethylene fraction. The temperature range of the second polyethylene fraction of 90° C. to 120° C. may be desirable because the low molecular weight, high density component at 90° C. to 120° C. may allow the polyethylene to achieve higher overall density while maintaining a lower density fraction.

According to one or more embodiments, the second polyethylene fraction area may comprise less than or equal to 50% of the total area of the elution profile (for example, less than or equal to 40%, less than or equal to 45%, or less than or equal to 30%, of the total area of the elution profile). For example, the second polyethylene fraction area may comprise from 10% to 50%, from 10% to 40%, from 10% to 30%, from 10% to 20%, from 20% to 50%, from 20% to 40%, from 20% to 30%, from 30% to 50%, from 30% to 40%, or from 40% to 50%, of the total area of the elution profile.

In one or more embodiments, the width of the single peak of the second polyethylene fraction at 50 percent peak height may be less than 10.0° C., less than 8.0° C., less than 6.0° C., less than 4.0° C., or even less than 2° C. Generally, lesser temperature ranges at 50 percent peak heights correspond to a “sharper” peak. Without being bound by any particular theory, it is believed that a “sharper” or “narrower” peak is a characteristic caused by the molecular catalyst and indicates minimum comonomer incorporation on the higher density fraction, enabling higher density split between the two fractions.

In one or more embodiments, the polyethylene composition may have a local minimum or “trough,” in a temperature range of from 80° C. to 95° C., from 80° C. to 90° C., from 80° C. to 85° C., from 85° C. to 95° C., from 85° C. to 90° C., or from 90° C. to 95° C. in the elution profile via iCCD, or any combination of these ranges. This local minimum may fall between the peaks of the first polyethylene fraction and the second polyethylene fraction.

According to one or more embodiments, the difference between the temperature of the single peak of the second polyethylene fraction and the temperature of the single peak of the first polyethylene fraction may be at least 10° C. For example, the difference between the single peak of the second polyethylene fraction and the single peak of the first polyethylene fraction may be at least 12° C., 14° C., 16° C., 18° C., or even at least 20° C.

According to some embodiments, a ratio of the first polyethylene fraction area to the second polyethylene fraction area may be from 2.0 to 4.0, from 2.0 to 3.5, from 2.0 to 3.0, from 2.0 to 2.5, from 2.5 to 4.0, from 2.5 to 3.5, from 2.5 to 3.0, from 3.0 to 4.0, from 3.0 to 3.5, from 3.5 to 4.0, or any combination of these ranges.

In one or more embodiments, the polyethylene composition is formed from the polymerization of ethylene and a comonomers such as a C3-C12 alkene. Contemplated comonomers include C6-C9 alkenes, such as 1-octene and 1-hexene. In one or more embodiments the comonomers is 1-octene.

In one or more embodiments, the first polyethylene fraction may have a melt index (I₂) of 0.01 to 0.18 g/10 minutes. For example, according to one or more embodiments, the first polyethylene fraction may have a melt index (I₂) of from 0.01 g/10 minutes to 0.03 g/10 minutes, from 0.03 g/10 minutes to 0.05 g/10 minutes, from 0.05 g/10 minutes to 0.07 g/10 minutes, from 0.07 g/10 minutes to 0.09 g/10 minutes, from 0.09 g/10 minutes to 0.11 g/10 minutes, from 0.11 g/10 minutes to 0.13 g/10 minutes, from 0.13 g/10 minutes to 0.15 g/10 minutes, from 0.15 g/10 minutes to 0.18 g/10 minutes, or any combination of these ranges.

In one or more embodiments, the second polyethylene fraction may have a melt index (I₂) of from 1 to 10,000 g/10 minutes. For example, according to one or more embodiments, the second polyethylene fraction may have a melt index (I₂) of from 10 g/10 minutes to 1,000 g/10 minutes, from 20 g/10 minutes to 800 g/10 minutes, from 1 g/10 minutes to 100 g/10 minutes, from 100 g/10 minutes to 1,000 g/10 minutes, from 1,000 g/10 minutes to 10,000 g/10 minutes, or any combination of these ranges.

In one or more embodiments, the weight average molecular weight of the second polyethylene fraction may be less than or equal to 100,000 g/mol, such as from 20,000 g/mol to 100,000 g/mol, or from 40,000 g/mol to 65,000 g/mol. In additional embodiments, the weight average molecular weight of the second polyethylene fraction may be from 20,000 g/mol to 40,000 g/mol, from 40,000 g/mol to 60,000 g/mol, from 60,000 g/mol to 80,000 g/mol, from 80,000 g/mol to 100,000 g/mol, or any combination of these ranges. Molecular weight of the polyethylene fractions may be calculated based on GPC results, as described hereinbelow.

The polyethylene compositions described herein may have relatively good dart strength when formed into monolayer blown films. According to one or more embodiments, a monolayer blown film formed from the polyethylene composition and having a thickness of two mils has a Dart drop impact of at least 1000 grams when measured according to ASTM D1709 Method A. In additional embodiments, a monolayer blown film formed from the polyethylene composition and having a thickness of two mils has a Dart drop impact of at least 1100 grams, at least 1200 grams, at least 1300 grams, at least 1400 grams, at least 1500 grams, at least 1600 grams, at least 1700 grams, at least 1800 grams, at least 1900 grams, or even at least 2000 grams when measured according to ASTM D1709 Method A.

In one or more embodiments, the presently disclosed polyethylene compositions may further comprise additional components such as one or more additives. Such additives include, but are not limited to, antistatic agents, color enhancers, dyes, lubricants, fillers such as TiO₂ or CaCO₃, opacifiers, nucleators, processing aids, pigments, primary anti-oxidants, secondary anti-oxidants, UV stabilizers, anti-blocks, slip agents, tackifiers, fire retardants, anti-microbial agents, odor reducer agents, anti-fungal agents, and combinations thereof. The polyethylene compositions may contain from about 0.1 to about 10 percent by the combined weight of such additives, based on the weight of the polyethylene composition including such additives.

### Polymerization

Any conventional polymerization processes may be employed to produce the polyethylene compositions described herein. Such conventional polymerization processes include, but are not limited to, slurry polymerization processes, solution polymerization process, using one or more conventional reactors, e.g., loop reactors, isothermal reactors, stirred tank reactors, batch reactors in parallel, series, and/or any combinations thereof. The polyethylene composition may, for example, be produced via solution phase polymerization process using one or more loop reactors, isothermal reactors, and combinations thereof.

In general, the solution phase polymerization process may occur in one or more well-mixed reactors such as one or more isothermal loop reactors or one or more adiabatic reactors at a temperature in the range of from 115 to 250° C. (e.g., from 115 to 210° C.), and at pressures in the range of from 300 to 1,000 psi (e.g., from 400 to 800 psi). In some embodiments, in a dual reactor, the temperature in the first reactor is in the range of from 115 to 190° C. (e.g., from 160 to 180° C.), and the second reactor temperature is in the range of 150 to 250° C. (e.g., from 180 to 220° C.). In other embodiments, in a single reactor, the temperature in the reactor is in the range of from 115 to 250° C. (e.g., from 115 to 225° C.).

The residence time in solution phase polymerization process may be in the range of from 2 to 30 minutes (e.g., from 5 to 25 minutes). Ethylene, solvent, hydrogen, one or more catalyst systems, optionally one or more cocatalysts, and optionally one or more comonomers are fed continuously to one or more reactors. Exemplary solvents include, but are not limited to, isoparaffins. For example, such solvents are commercially available under the name ISOPAR E from ExxonMobil Chemical Co., Houston, Texas. The resultant mixture of the polyethylene composition and solvent is then removed from the reactor and the polyethylene composition is isolated. Solvent is typically recovered via a solvent recovery unit, e.g., heat exchangers and vapor liquid separator drum, and is then recycled back into the polymerization system.

In some embodiments, the polyethylene composition may be produced via solution polymerization in a dual reactor system, for example a dual loop reactor system, wherein ethylene is polymerized in the presence of one or more catalyst systems. In some embodiments, only ethylene is polymerized. Additionally, one or more cocatalysts may be present. In another embodiment, the polyethylene composition may be produced via solution polymerization in a single reactor system, for example a single loop reactor system, wherein ethylene is polymerized in the presence of two catalyst systems. In some embodiments, only ethylene is polymerized.

### Catalyst Systems

Common abbreviations are listed below:

Me: methyl; Et: ethyl; Ph: phenyl; Bn: benzyl; i-Pr: iso-propyl; t-Bu: tert-butyl; t-Oct: tert-octyl (2,4,4-trimethylpentan-2-yl); Tf: trifluoromethane sulfonate; THF: tetrahydrofuran; Et₂O: diethyl ether; CH₂Cl₂: dichloromethane; CV: column volume (used in column chromatography); EtOAc: ethyl acetate; C₆D₆: deuterated benzene or benzene-d6: CDCl₃: deuterated chloroform; Na₂SO₄: sodium sulfate; MgSO₄: magnesium sulfate; HCl: hydrogen chloride; n-BuLi: butyllithium; t-BuLi: tert-butyllithium; MAO: methylaluminoxane; MMAO: modified methylaluminoxane; GC: gas chromatography; LC: liquid chromatography; NMR: nuclear magnetic resonance; MS: mass spectrometry; mmol: millimoles; mL: milliliters; M: molar; min or mins: minutes; h or hrs: hours; d: days.

Specific embodiments of catalyst systems that can, in one or more embodiments, be used to produce the polyethylene compositions described herein will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

The term “independently selected” is used herein to indicate that the R groups, such as, R¹, R², R³, R⁴, and R⁵, can be identical or different (e.g., R¹, R², R³, R⁴, and R⁵ may all be substituted alkyls or R¹ and R² may be a substituted alkyl and R³ may be an aryl, etc). A chemical name associated with an R group is intended to convey the chemical structure that is recognized in the art as corresponding to that of the chemical name. Thus, chemical names are intended to supplement and illustrate, not preclude, the structural definitions known to those of skill in the art.

The term “procatalyst” refers to a transition metal compound that has olefin polymerization catalytic activity when combined with an activator. The term “activator” refers to a compound that chemically reacts with a procatalyst in a manner that converts the procatalyst to a catalytically active catalyst. As used herein, the terms “cocatalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀) alkyl is an alkyl group having from 1 to 50 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom of a corresponding unsubstituted compound or functional group is replaced by a substituent (e.g. R^{S}). The term “—H” means a hydrogen or hydrogen radical that is covalently bonded to another atom. “Hydrogen” and “—H” are interchangeable, and unless clearly specified have identical meanings.

The term “(C₁-C₅₀)alkyl” means a saturated straight or branched hydrocarbon radical containing from 1 to 50 carbon atoms; and the term “(C₁-C₃₀)alkyl” means a saturated straight or branched hydrocarbon radical of from 1 to 30 carbon atoms. Each (C₁-C₅₀)alkyl and (C₁-C₃₀)alkyl may be unsubstituted or substituted by one or more R^{S}. In some examples, each hydrogen atom in a hydrocarbon radical may be substituted with R^{S}, such as, for example trifluoromethyl. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅)alkyl, such as, for example, methyl, trifluoromethyl, ethyl, 1-propyl, 1-methylethyl, or 1,1-dimethylethyl.

The term (C₃-C₅₀)alkenyl means a branched or unbranched, cyclic or acyclic monovalent hydrocarbon radical containing from 3 to 50 carbon atoms, at least one double bond and is unsubstituted or substituted by one or more R^{S}. Examples of unsubstituted (C₃-C₅₀)alkenyl: n-propenyl, isopropenyl, n-butenyl, isobutenyl, octenyl, decenyl, cyclopentenyl, cyclopentadienyl, cyclohexenyl, and cyclohexadienyl. Examples of substituted (C₃-C₅₀)alkenyl: (2-trifluoromethyl)pent-1-enyl, (3-methyl)hex-1-eneyl, (3-methyl)hexa-1,4-dienyl and (Z)-1-(6-methylhept-3-en-1-yl)cyclohex-1-eneyl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀) cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, and 1-fluorocyclohexyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double or triple bonds optionally may be present in substituents R^{S}. The term “unsaturated” means containing one or more carbon-carbon double bonds or carbon-carbon triple bonds, or (in heteroatom-containing groups) one or more carbon-nitrogen double bonds, carbon-phosphorous double bonds, or carbon-silicon double bonds, not including double bonds that may be present in substituents R^{S}, if any, or in aromatic rings or heteroaromatic rings, if any.

The term “(C₁-C₄₀)hydrocarbyl” means a hydrocarbon radical of from 1 to 40 carbon atoms and the term “(C₁-C₄₀)hydrocarbylene” means a hydrocarbon diradical of from 1 to 40 carbon atoms, in which each hydrocarbon radical and each hydrocarbon diradical is aromatic or non-aromatic, saturated or unsaturated, straight chain or branched chain, cyclic (including mono- and poly-cyclic, fused and non-fused polycyclic, including bicyclic; 3 carbon atoms or more) or acyclic and is unsubstituted or substituted by one or more R^{S}.

In this disclosure, a (C₁-C₄₀)hydrocarbyl can be an unsubstituted or substituted (C₁-C₄₀)alkyl, (C₃-C₄₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene. In some embodiments, each of the aforementioned (C₁-C₄₀)hydrocarbyl groups has a maximum of 20 carbon atoms (i.e., (C₁-C₂₀)hydrocarbyl) and embodiments, a maximum of 12 carbon atoms.

The term “(C₆-C₄₀)aryl” means an unsubstituted or substituted (by one or more R^{S}) mono-, bi- or tricyclic aromatic hydrocarbon radical of from 6 to 40 carbon atoms, of which at least from 6 to 14 of the carbon atoms are aromatic ring carbon atoms, and the mono-, bi- or tricyclic radical comprises 1, 2, or 3 rings, respectively; wherein the 1 ring is aromatic and the 2 or 3 rings independently are fused or non-fused and at least one of the 2 or 3 rings is aromatic. Examples of unsubstituted (C₆-C₄₀)aryl are unsubstituted (C₆-C₂₀)aryl unsubstituted (C₆-C₁₈)aryl; 2-(C₁-C₅)alkyl-phenyl; 2,4-bis(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl are substituted (C₁-C₂₀)aryl; substituted (C₆-C₁₈)aryl; 2,4-bis[(C₂₀)alkyl]-phenyl; polyfluorophenyl; pentafluorophenyl; and fluoren-9-one-1-yl.

Examples of (C₁-C₄₀)hydrocarbylene include unsubstituted or substituted (C₆-C₄₀)arylene, (C₃-C₄₀)cycloalkylene, and (C₁-C₄₀)alkylene (e.g., (C₁-C₂₀)alkylene). In some embodiments, the diradicals are on the same carbon atom (e.g., —CH₂—) or on adjacent carbon atoms (i.e., 1,2-diradicals), or are spaced apart by one, two, or more than two intervening carbon atoms (e.g., respective 1,3-diradicals, 1,4-diradicals, etc.). Some diradicals include α,ω-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e. —CH₂CH₂CH₂—), 2-methylpropan-1,3-diyl (i.e. —CH₂CH(CH₃)CH₂—). Some examples of (C₆-C₅₀)arylene α,ω-diradicals include phenyl-1,4-diyl, napthalen-2,6-diyl, or napthalen-3,7-diyl.

The term “(C₁-C₄₀)alkylene” means a saturated straight chain or branched chain diradical (i.e., the radicals are not on ring atoms) of from 1 to 40 carbon atoms that is unsubstituted or substituted by one or more R^{S}. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-C₁₈)alkylene, examples of substituted (C₁-C₅₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis (methylene)bicyclo[2.2.2]octane.

The term “(C₃-C₄₀)cycloalkylene” means a cyclic diradical (i.e., the radicals are on ring atoms) of from 3 to 40 carbon atoms that is unsubstituted or substituted by one or more R^{S}.

The term “heteroatom,” refers to an atom other than hydrogen or carbon. Examples of heteroatoms include O, S, S(O), S(O)₂, Si(R^{C})₂, P(R^{P}), N(R^{N}), —N═C(R^{C})₂, —Ge(R^{C})₂—, or —Si(R^{C})—, where each R^{C}, each R^{N}, and each R^{P} is unsubstituted (C₁-C₁₈)hydrocarbyl or —H. The term “heterohydrocarbon” refers to a molecule or molecular framework in which one or more carbon atoms are replaced with a heteroatom. The term “(C₁-C₄₀)heterohydrocarbyl” means a heterohydrocarbon radical of from 1 to 40 carbon atoms and the term “(C₁-C₄₀)heterohydrocarbylene” means a heterohydrocarbon diradical of from 1 to 40 carbon atoms, and each heterohydrocarbon has one or more heteroatoms. The radical of the heterohydrocarbyl is on a carbon atom or a heteroatom, and diradicals of the heterohydrocarbyl may be on: (1) one or two carbon atom, (2) one or two heteroatoms, or (3) a carbon atom and a heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₄₀)heterohydrocarbyl may be unsubstituted or substituted (C₁-C₄₀)heteroalkyl, (C₁-C₄₀)hydrocarbyl-O—, (C₁-C₄₀)hydrocarbyl-S—, (C₁-C₄₀)hydrocarbyl-S(O)—, (C₁-C₄₀)hydrocarbyl-S(O)₂—, (C₁-C₄₀)hydrocarbyl-Si(R^{C})₂—, (C₁-C₄₀)hydrocarbyl-N(R^{N})—, (C₁-C₄₀)hydrocarbyl-P(R^{P})—, (C₂-C₄₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₄₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₄-C₄₀)heteroaryl” means an unsubstituted or substituted (by one or more R^{S}) mono-, bi- or tricyclic heteroaromatic hydrocarbon radical of from 4 to 40 total carbon atoms and from 1 to 10 heteroatoms, and the mono-, bi- or tricyclic radical comprises 1, 2 or 3 rings, respectively, wherein the 2 or 3 rings independently are fused or non-fused and at least one of the 2 or 3 rings is heteroaromatic. Other heteroaryl groups (e.g., (Cₓ-C_{y})heteroaryl generally, such as (C₄-C₁₂)heteroaryl) are defined in an analogous manner as having from x to y carbon atoms (such as 4 to 12 carbon atoms) and being unsubstituted or substituted by one or more than one R^{S}. The monocyclic heteroaromatic hydrocarbon radical is a 5-membered or 6-membered ring. The 5-membered ring has 5 minus h carbon atoms, wherein h is the number of heteroatoms and may be 1, 2, 3 or 4; and each heteroatom may be O, S, N, or P. Examples of 5-membered ring heteroaromatic hydrocarbon radical are pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 6 minus h carbon atoms, wherein h is the number of heteroatoms and may be 1 or 2 and the heteroatoms may be N or P. Examples of 6-membered ring heteroaromatic hydrocarbon radical are pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f]indol-1-yl. An example of the fused 6,5,6-ring system is 9H-carbazol-9-yl. An example of the fused 6,6,6-ring system is acrydin-9-yl.

The aforementioned heteroalkyl may be saturated straight or branched chain radicals containing (C₁-C₅₀) carbon atoms, or fewer carbon atoms and one or more of the heteroatoms. Likewise, the heteroalkylene may be saturated straight or branched chain diradicals containing from 1 to 50 carbon atoms and one or more than one heteroatoms. The heteroatoms, as defined above, may include Si(R^{C})₃, Ge(R^{C})₃, Si(R^{C})₂, Ge(R^{C})₂, P(R^{P})₂, P(R^{P}), N(R^{N})₂, N(R^{N}), N, O, OR^{C}, S, SR^{C}, S(O), and S(O)₂, wherein each of the heteroalkyl and heteroalkylene groups are unsubstituted or substituted by one or more R^{S}.

Examples of unsubstituted (C₂-C₄₀)heterocycloalkyl are unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

In one or more embodiments, the catalyst system includes hydrocarbyl-modified methylaluminoxane and a metal-ligand complex. The hydrocarbyl-modified methylaluminoxane having less than 25 mole percent trihydrocarbyl aluminum based on the total moles of aluminum in the hydrocarbyl-modified methylaluminoxane. The trihydrocarbyl aluminum has a formula of AlR^{A1}R^{B1}R^{C1}, where R^{A1}, R^{B1}, and R^{C1} are independently (C₁-C₄₀)alkyl.

In embodiments, the hydrocarbyl-modified methylaluminoxane in the polymerization process has less than 20 mole percent and greater than 5 mole percent of trihydrocarbyl aluminum based on the total moles of aluminum in the hydrocarbyl-modified methylaluminoxane. In some embodiments, the hydrocarbyl-modified methylaluminoxane has less than 15 mole percent of trihydrocarbyl aluminum based on the total moles of aluminum in the hydrocarbyl-modified methylaluminoxane. In one or more embodiments, the hydrocarbyl-modified methylaluminoxane has less than 10 mole percent of trihydrocarbyl aluminum based on the total moles of aluminum in the hydrocarbyl-modified methylaluminoxane. In various embodiments, the hydrocarbyl-modified methylaluminoxane is modified methylaluminoxane.

In some embodiments, the trihydrocarbyl aluminum has a formula of AlR^{A1}R^{B1}R^{C1}, where R^{A1}, R^{B1}, and R^{C1} are independently (C₁-C₁₀)alkyl. In one or more embodiments, R^{A1}, R^{B1}, and R^{C1} are independently methyl, ethyl, propyl, 2-propyl, butyl, tert-butyl, or octyl. In some embodiment, R^{A1}, R^{B1}, and R^{C1} are the same. In other embodiments, at least one of R^{A1}, R^{B1}, and R^{C1} is different from the other R^{A1}, R^{B1}, and R^{C1}.

The term “hydrocarbyl-modified methylaluminoxane” refers to a methylaluminoxane (MMAO) structure comprising an amount of trihydrocarbyl aluminum. The hydrocarbyl-modified methylaluminoxane includes a combination of a hydrocarbyl-modified methylaluminoxane matrix and trihydrocarbylaluminum. A total molar amount of aluminum in the hydrocarbyl-modified methylaluminoxane is composed of the aluminum contribution from the moles of aluminum from the hydrocarbyl-modified methylaluminoxane matrix and moles of aluminum from the trihydrocarbyl aluminum. The hydrocarbyl-modified methylaluminoxane includes greater than 2.5 mole percent of trihydrocarbylaluminum based on the total moles of aluminum in the hydrocarbyl-modified methylaluminoxane. These additional hydrocarbyl substituents can impact the subsequent aluminoxane structure and result in differences in the distribution and size of aluminoxane clusters (Bryliakov, K. P et. al. Macromol. Chem. Phys. 2006, 207, 327-335). The additional hydrocarbyl substituents can also impart increased solubility of the aluminoxane in hydrocarbon solvents such as, but not limited to, hexane, heptane, methylcyclohexane, and ISOPAR E™ as demonstrated in U.S. Pat. No. 5,777,143. Modified methylaluminoxane compositions are generically disclosed and can be prepared as described in U.S. Pat. Nos. 5,066,631 and 5,728,855, both of which are incorporated herein by reference.

According to some embodiments, a catalyst system for producing a polyethylene composition includes a metal-ligand complex according to formula (I):

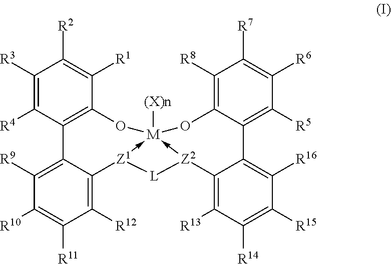

In formula (I), M is a metal chosen from titanium, zirconium, hafnium, scandium, yttrium, or an element of the lanthanide series of the periodic table; n is 0, 1, or 2; when n is 1, X is a monodentate ligand or a bidentate ligand; when n is 2, each X is a monodentate ligand and is the same or different; the metal-ligand complex is overall charge-neutral; each Z is independently chosen from —O—, —S—, —N(R^{N})—, or —P(R^{P})—; L is (C₁-C₄₀)hydrocarbylene or (C₁-C₄₀)heterohydrocarbylene, wherein the (C₁-C₄₀)hydrocarbylene has a portion that comprises a 1-carbon atom to 10-carbon atom linker backbone linking the two Z groups in Formula (I) (to which L is bonded) or the (C₁-C₄₀)heterohydrocarbylene has a portion that comprises a 1-atom to 10-atom linker backbone linking the two Z groups in Formula (I), wherein each of the 1 to 10 atoms of the 1-atom to 10-atom linker backbone of the (C₁-C₄₀)heterohydrocarbylene independently is a carbon atom or heteroatom, wherein each heteroatom independently is O, S, S(O), S(O)₂, Si(R^{C})₂, Ge(R^{C})₂, P(R^{C}), or N(R^{C}), wherein independently each R^{C} is (C₁-C₃₀)hydrocarbyl or (C₁-C₃₀)heterohydrocarbyl; R¹ and R⁸ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, and radicals having formula (II), formula (III), or formula (IV):

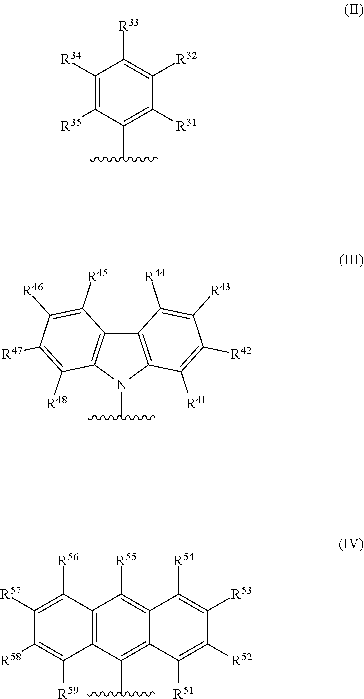

In formulas (II), (III), and (IV), each of R³¹⁻³⁵, R⁴¹⁻⁴⁸, or R⁵¹⁻⁵⁹ is independently chosen from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N═CHR^{C}, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, or —H, provided at least one of R¹ or R⁸ is a radical having formula (II), formula (III), or formula (IV).

In formula (I), each of R²⁻⁴, R⁵⁻⁷, and R⁹⁻¹⁶ is independently selected from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N—CHR^{C}, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, halogen, and —H.

In some embodiments, the polyethylene composition is formed using a first metal-ligand complex according to formula (I) in a first reactor and a different metal-ligand complex according to formula (I) in a second reactor.

In one exemplary embodiment where a dual loop reactor is used, the metal-ligand complex used the loop in first is zirconium, [[2,2′″-[[bis[1-methylethyl)germylene]bis(methyleneoxy-κO)]bis[3″,5,5″-tris(1,1-dimethylethyl)-5′-octyl[1,1′:3′,1″-terphenyl]-2′-olato-κO]](2-)]dimethyl-, prepared according to the procedures of WO 2018/183056, incorporated herein by reference, having the chemical formula C₈₆H₁₂₈F₂GeO₄Zr, and having the following structure (V):

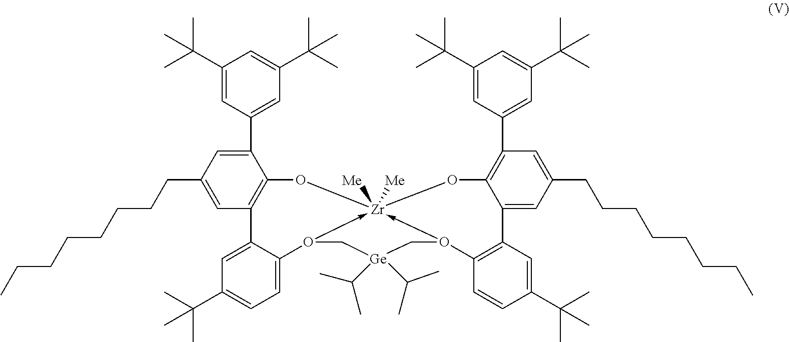

In such an embodiment, the metal-ligand complex used in the second loop is zirconium, [[2,2′″-[1,3-propanediylbis(oxy-κO)]bis[3-[2,7-bis(1,1-dimethylethyl)-9H-carbazol-9-yl]]-5′-(dimethyloctylsilyl)-3′-methyl-5-(1,1,3,3-tetramethylbutyl)[1,1]-biphenyl]-2-olato-κO]](2-)]dimethyl, prepared according to the procedures of WO 2017/058981, incorporated herein by reference, having the chemical formula C₁₀₇H₁₅₄N₂O₄Si₂Zr, and the following structure (VI):

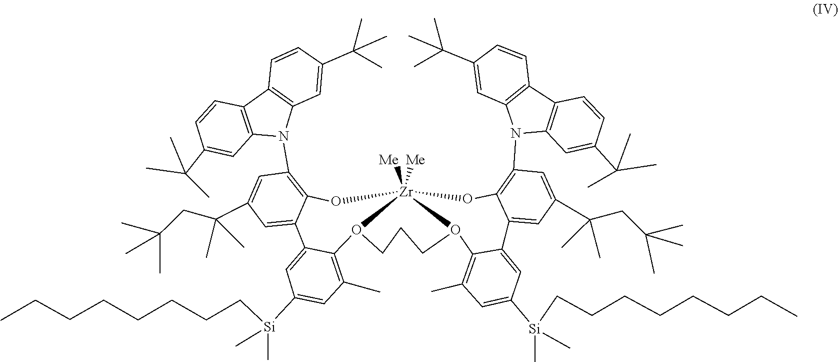

### Cocatalyst Component

The catalyst system comprising a metal-ligand complex of formula (I) may be rendered catalytically active by any technique known in the art for activating metal-based catalysts of olefin polymerization reactions. For example, the system comprising a metal-ligand complex of formula (I) may be rendered catalytically active by contacting the complex to, or combining the complex with, an activating cocatalyst.

Additionally, the metal-ligand complex according to formula (I) includes both a procatalyst form, which is neutral, and a catalytic form, which may be positively charged due to the loss of a monoanionic ligand, such a benzyl or phenyl. Suitable activating cocatalysts for use herein include oligomeric alumoxanes, modified alkyl aluminoxanes or hydrocarbyl-modified methylaluminoxanes.

Suitable activating cocatalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating cocatalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Lewis acid activators (cocatalysts) include Group 13 metal compounds containing from 1 to 3 (C₁-C₂₀)hydrocarbyl substituents as described herein. In one embodiment, Group 13 metal compounds are tri((C₁-C₂₀)hydrocarbyl)-substituted-aluminum or tri((C₁-C₂₀)hydrocarbyl)-boron compounds. In embodiments, Group 13 metal compounds are tri(hydrocarbyl)-substituted-aluminum, tri((C₁-C₂₀)hydrocarbyl)-boron compounds, tri((C₁-C₁₀)alkyl)aluminum, tri((C₆-C₁₈)aryl)boron compounds, and halogenated (including perhalogenated) derivatives thereof. In further embodiments, Group 13 metal compounds are tris(fluoro-substituted phenyl)boranes, tris(pentafluorophenyl)borane. In some embodiments, the activating cocatalyst is a tris((C₁-C₂₀)hydrocarbyl borate (e.g. trityl tetrafluoroborate) or a tri((C₁-C₂₀)hydrocarbyl)ammonium tetra((C₁-C₂₀)hydrocarbyl)borate (e.g. bis(octadecyl)methylammonium tetrakis(pentafluorophenyl)borate). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different.

Combinations of neutral Lewis acid activators (cocatalysts) include mixtures comprising a combination of a tri((C₁-C₄)alkyl)aluminum and a halogenated tri((C₆-C₁₈)aryl)boron compound, especially a tris(pentafluorophenyl)borane. Embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex):(tris(pentafluoro-phenylborane):(alumoxane) [e.g., (Group 4 metal-ligand complex):(tris(pentafluoro-phenylborane):(alumoxane)] are from 1:1:1 to 1:10:30, in embodiments, from 1:1:1.5 to 1:5:10

The catalyst system comprising the metal-ligand complex of formula (I) may be activated to form an active catalyst composition by combination with one or more cocatalysts, for example, a cation forming cocatalyst, a strong Lewis acid, or combinations thereof. Suitable activating cocatalysts include polymeric or oligomeric aluminoxanes, especially methyl aluminoxane, as well as inert, compatible, noncoordinating, ion forming compounds. Exemplary suitable cocatalysts include, but are not limited to: modified methyl aluminoxane (MMAO), bis(hydrogenated tallow alkyl)methyl tetrakis(pentafluorophenyl)borate(1⁻) amine, and combinations thereof.

In some embodiments, one or more of the foregoing activating cocatalysts are used in combination with each other. An especially preferred combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of formula (I) to total number of moles of one or more of the activating cocatalysts is from 1:10,000 to 100:1. In some embodiments, the ratio is at least 1:5000, in some embodiments, at least 1:1000; and 10:1 or less, and in some embodiments, 1:1 or less. When an alumoxane alone is used as the activating cocatalyst, preferably the number of moles of the alumoxane that are employed is at least 25 times the number of moles of the metal-ligand complex of formula (I). When tris(pentafluorophenyl)borane alone is used as the activating cocatalyst, in some embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1. The remaining activating cocatalysts are generally employed in approximately mole quantities equal to the total mole quantities of one or more metal-ligand complexes of formula (I).

### Films

In some embodiments, the presently-disclosed embodiments relate to films formed from any of the presently-disclosed polyethylene compositions as described herein. In some embodiments, the film may be a blown film or a cast film. In embodiments, the film may be an extrusion coated film. In embodiments, the film may be a blown machine directed oriented film or a cast film tenter frame oriented film. In some embodiments, the film may be a monolayer film. The film, in some embodiments, may be a multilayer film. In some embodiments of multilayer films that include the presently-disclosed polyethylene compositions, a multilayer film may include a polyethylene composition of the present disclosure in a surface layer and/or in an inner layer. In embodiments, the presently-disclosed polyethylene compositions may be in a sealant layer of a multilayer film, where applying the multimodal polyethylene composition described herein to at least one surface of a substrate layer, thereby forms a sealant layer associated with the at least one surface of the substrate layer. The sealant layer may be applied to the substrate layer of a blown film or a cast film, for example, by a coextrusion process. In embodiments, the sealant layer may be directly applied to the substrate layer as an extrusion coating. A sealant layer may provide a heat-sealable surface. As used herein, a heat-sealable surface is a surface that may allow the surface of the film to be heat-sealed to another surface of the same film or to the surface of another film or substrate.

In one or more embodiments, the presently-disclosed polyethylene compositions may be blended with other polymers, such as other polyethylenes or even other non-polyethylene-based polymers. For example, the presently-disclosed polyethylene compositions may be blended with conventional polyethylene compositions such as, without limitation, LDPEs, LLDPEs, MDPEs, and/or HDPEs, known to those skilled in the art.

The amount of the polyethylene composition used in films of the present embodiments can depend on a number of factors including, for example, whether the film is a monolayer or multilayer film, the other layers in the film if it is a multilayer film, the end use application of the film, and others.

Films of the present disclosure can have a variety of thicknesses. The thickness of the film can depend on a number of factors including, for example, whether the film is a monolayer or multilayer film, the other layers in the film if it is a multilayer film, the desired properties of the film, the end use application of the film, the equipment available to manufacture the film, and others. In some embodiments, a film of the present disclosure has a thickness of up to 10 mils. For example, the film can have a thickness from a lower limit of 0.25 mils, 0.5 mils, 0.7 mils, 1.0 mil, 1.75 mils, or 2.0 mils to an upper limit of 4.0 mils, 6.0 mils, 8.0 mils, or 10 mils. In embodiments, the film can have a thickness from 0.25 mils, to 2.0 mils, from 0.25 mils to 1.75 mils, from 0.25 mils to 1.0 mils, from 0.25 mils to 0.7 mils, from 0.25 mils to 0.5 mils, from 0.5 mils, to 2.0 mils, from 0.5 mils to 1.75 mils, from 0.5 mils to 1.0 mils, from 0.5 mils to 0.7 mils, from 0.7 mils, to 2.0 mils, from 0.7 mils to 1.75 mils, from 0.7 mils to 1.0 mils, from 1.0 mils, to 2.0 mils, from 1.0 mils to 1.75 mils, from 1.75 mils, to 2.0 mils, or any combinations.

In embodiments where the film comprises a multilayer film, the number of layers in the film can depend on a number of factors including, for example, the desired properties of the film, the desired thickness of the film, the content of the other layers of the film, the end use application of the film, the equipment available to manufacture the film, and others. A multilayer blown film can comprise up to 2, 3, 4, 5, 6, 7, 8, 9, 10, or 11 layers in various embodiments.

The polyethylene compositions, in some embodiments, can be used in more than one layer of the film. Other layers within a multilayer film of the present disclosure can comprise, in various embodiments, a polymer selected from the following: the presently-disclosed polyethylene compositions, a LLDPE, a VLDPE (a very low density polyethylene), a MDPE, a LDPE, a HDPE, a HMWHDPE (a high molecular weight HDPE), a propylene-based polymer, a polyolefin plastomer (POP), a polyolefin elastomer (POE), an olefin block copolymer (OBC), an ethylene vinyl acetate, an ethylene acrylic acid, an ethylene methacrylic acid, an ethylene methyl acrylate, an ethylene ethyl acrylate, an ethylene butyl acrylate, an isobutylene, a maleic anhydride-grafted polyolefin, an ionomer of any of the foregoing, or a combination thereof. In some embodiments, a multilayer film of the present disclosure can comprise one or more tie layers known to those of skill in the art.

In additional embodiments of the films described herein, other layers may be adhered to, for example, a polyethylene film by a tie layer (sometimes in addition to a barrier layer). A tie layer may be used to adhere layers of dissimilar materials. For example, a barrier layer comprising ethylene vinyl alcohol (EVOH) may be adhered to a polyethylene material by a tie layer (i.e. a tie layer comprising maleic anhydride grafted polyethylene). For example, the polyolefin film can further comprise other layers typically included in multilayer structures depending on the application including, for example, other barrier layers, structural or strength layers, sealant layers, other tie layers, other polyethylene layers, polypropylene layers, etc. In additional embodiments, a printed layer may be included that may be an ink layer, which is applied to the film, to show product details and other packaging information in various colors.

It should be understood that any of the foregoing layers can further comprise one or more additives as known to those of skill in the art such as, for example, antioxidants, ultraviolet light stabilizers, thermal stabilizers, slip agents, antiblocks, pigments or colorants, processing aids, crosslinking catalysts, flame retardants, fillers and foaming agents. In some embodiments, the polyethylene compositions comprise up to 5 weight percent of such additional additives. All individual values and subranges from 0 to 5 wt. % are included and disclosed herein; for example, the total amount of additives in the polymer blend can be from a lower limit of 0, 0.5, 1, 1.5, 2, or 2.5 wt. % to an upper limit of 1.5, 2, 2.5, 3, 3.5, 4, 4.5, or 5 wt. %. In embodiments, the total amount of additives in the polymer blend can be from 0 wt. % to 5 wt. %, 0 wt. % to 4.5 wt. %, 0 wt. % to 4 wt. %, 0 wt. % to 3.5 wt. %, 0 wt. % to 3 wt. %, 0 wt. % to 2.5 wt. %, 0 wt. % to 2 wt. %, 0 wt. % to 1.5 wt. %, 0 wt. % to 1 wt. %, 0 wt. % to 0.5 wt. %, 0.5 wt. % to 5 wt. %, 0.5 wt. % to 4.5 wt. %, 0.5 wt. % to 4 wt. %, 0.5 wt. % to 3.5 wt. %, 0.5 wt. % to 3 wt. %, 0.5 wt. % to 2.5 wt. %, 0.5 wt. % to 2 wt. %, 0.5 wt. % to 1.5 wt. %, 0.5 wt. % to 1 wt. %, 1 wt. % to 5 wt. %, 1 wt. % to 4.5 wt. %, 1 wt. % to 4 wt. %, 1 wt. % to 3.5 wt. %, 1 wt. % to 3 wt. %, 1 wt. % to 2.5 wt. %, 1 wt. % to 2 wt. %, 1 wt. % to 1.5 wt. %, 1.5 wt. % to 5 wt. %, 1.5 wt. % to 4.5 wt. %, 1.5 wt. % to 4 wt. %, 1.5 wt. % to 3.5 wt. %, 1.5 wt. % to 3 wt. %, 1.5 wt. % to 2.5 wt. %, 1.5 wt. % to 2 wt. %, 2 wt. % to 5 wt. %, 2 wt. % to 4.5 wt. %, 2 wt. % to 4 wt. %, 2 wt. % to 3.5 wt. %, 2 wt. % to 3 wt. %, 2 wt. % to 2.5 wt. %, 2.5 wt. % to 5 wt. %, 2.5 wt. % to 4.5 wt. %, 2.5 wt. % to 4 wt. %, 2.5 wt. % to 3.5 wt. %, 2.5 wt. % to 3 wt. %, 3 wt. % to 5 wt. %, 3 wt. % to 4.5 wt. %, 3 wt. % to 4 wt. %, 3 wt. % to 3.5 wt. %, 3.5 wt. % to 5 wt. %, 3.5 wt. % to 4.5 wt. %, 3.5 wt. % to 4 wt. %, 4 wt. % to 5 wt. %, 4 wt. % to 4.5 wt. %, or 4.5 wt. % to 5 wt. %, or any combinations of these ranges.

The presently-disclosed polyethylene compositions, according to some embodiments, can be incorporated into multilayer films and articles that are comprised primarily, if not substantially or entirely, of polyolefins, or more preferably, of polyethylene, in order to provide a film and article that is more easily recyclable. The polyethylene-based compositions of the present disclosure are particularly advantageous in proving films wherein the film is formed primarily from polyethylene. For example, a monolayer or multilayer film wherein the film primarily comprises polyethylene may have an improved recyclability profile in addition to other advantages that the usage of such polymers may provide. In some embodiments, the film comprises 90 wt. % or more polyethylene based on the total weight of the film. In other embodiments, the film comprises 91 wt. % or more, 92 wt. % or more, 93 wt. % or more, 94 wt. % or more, 95 wt. % or more, 96 wt. % or more, 97 wt. % or more, 98 wt. % or more, or 99 wt. % or more polyethylene based on the total weight of the film.

In some embodiments, the film comprising a layer formed from the presently-disclosed polyethylene compositions can be laminated to another film substrate. Substrates may include films comprising polyester, nylon, polypropylene, polyethylene, and combinations. For preferred recyclability substrates, a biaxially oriented polyethylene (BOPE) substrate, a machine direction oriented polyethylene (MDO) substrate, or a coextruded polyethylene film may be included in the laminate structure.

In some embodiments, the film comprising a layer formed from the presently disclosed polyethylene compositions can be laminated to another film.

Films of the present disclosure, in some embodiments, can be corona treated and/or printed (e.g., reverse or surface printed) using techniques known to those of skill in the art.

In some embodiments, films of the present disclosure can be oriented, uniaxially (e.g., in the machine direction) or biaxially using techniques known to those of skill in the art.

In embodiments, a monolayer blown film formed from the polyethylene compositions comprised herein, having a thickness of two mils may have a Dart drop impact of at least 1000 grams when measured according to ASTM D1709 Method A. In additional embodiments, a monolayer blown film formed from the polyethylene composition and having a thickness of two mils may have a Dart drop impact of at least 1100 grams, at least 1200 grams, at least 1300 grams, at least 1400 grams, at least 1500 grams, at least 1600 grams, at least 1700 grams, at least 1800 grams, at least 1900 grams, or even at least 2000 grams when measured according to ASTM D1709 Method A.

### Articles

Embodiments of the present disclosure also relate to articles, such as packages, formed from or incorporating polyethylene compositions of the present disclosure (or films incorporating polyethylene compositions of the present disclosure). Such packages can be formed from any of the polyethylene compositions of the present disclosure (or films incorporating polyethylene-based compositions of the present disclosure) described herein.

Examples of such articles can include flexible packages, pouches, stand-up pouches, and pre-made packages or pouches. In some embodiments, multilayer films or laminates of the present disclosure can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

### TEST METHODS

Unless otherwise indicated herein, the following analytical methods are used in describing aspects of the present disclosure:

### Melt index

Melt indices I₂ (or I2) and I₁₀ (or I10) of polymer samples were measured in accordance to ASTM D-1238 (method B) at 190° C. and at 2.16 kg and 10 kg load, respectively. Their values are reported in g/10 min. Fractions of polymer samples were measured by collecting product polymer from the reactor which produces that specific fraction or portion of the polymer composition. For example, the first polyethylene fraction can be collected from the reactor producing the lower density, higher molecular weight component of the polymer composition. The polymer solution is dried under vacuum before the melt index measurement.

### Density

Samples for density measurement were prepared according to ASTM D4703. Measurements were made, according to ASTM D792, Method B, within one hour of sample pressing.

### ASTM D1709 Dart Drop

The film Dart Drop test determines the energy that causes plastic film to fail under specified conditions of impact by a free falling dart. The test result is the energy, expressed in terms of the weight of the missile falling from a specified height, which would result in failure of 50% of the specimens tested.

After the film is produce, it is conditioned for at least 40 hours at 23° C. (+/−2° C.) and 50% R.H (+/−10) as per ASTM standards. Standard testing conditions are 23° C. (+/−2° C.) and 50% R.H (+/−10) as per ASTM standards.

The test result is reported by Method A, which uses a 1.5″ diameter dart head and 26″ drop height. The sample thickness is measured at the sample center and the sample then clamped by an annular specimen holder with an inside diameter of 5 inches. The dart is loaded above the center of the sample and released by either a pneumatic or electromagnetic mechanism.

Testing is carried out according to the ‘staircase’ method. If the sample fails, a new sample is tested with the weight of the dart reduced by a known and fixed amount. If the sample does not fail, a new sample is tested with the weight of the dart increased by a known amount. After 20 specimens have been tested the number of failures is determined. If this number is 10 then the test is complete. If the number is less than 10 then the testing continues until 10 failures have been recorded. If the number is greater than 10, testing is continued until the total of non-failures is 10. The Dart drop strength is determined from these data as per ASTM D1709 and expressed in grams as the dart drop impact of Type A. All the samples analyzed were 2 mil thick.

### Instrumented Dart Impact

Instrumented dart impact method is measured according to ASTM D7192 on plastic film specimens using an Instron CEAST 9350 impact tester. The test is conducted using 12.7 mm diameter tup with hemispherical head, 75 mm diameter clamping assembly with rubber faced grips. The instrument is equipped with an enviromental chamber for testing at low or high temperature. Typical specimen size is 125 mm×125 mm. Standard test velocity is 200 m/min. Film thickness is 2 mil.

### Creep Zero Shear Viscosity Measurement Method

Zero-shear viscosities are obtained via creep tests that were conducted on an AR-G2 stress controlled rheometer (TA Instruments; New Castle, Del) using 25-mm-diameter parallel plates at 190° C. The rheometer oven is set to test temperature for at least 30 minutes prior to zeroing fixtures. At the testing temperature a compression molded sample disk is inserted between the plates and allowed to come to equilibrium for 5 minutes. The upper plate is then lowered down to 50 μm above the desired testing gap (1.5 mm). Any superfluous material is trimmed off and the upper plate is lowered to the desired gap. Measurements are done under nitrogen purging at a flow rate of 5 L/min. Default creep time is set for 2 hours.

A constant low shear stress of 20 Pa is applied for all of the samples to ensure that the steady state shear rate is low enough to be in the Newtonian region. The resulting steady state shear rates are in the range of 10⁻³ to 10⁻⁴ s⁻¹ for the samples in this study. Steady state is determined by taking a linear regression for all the data in the last 10% time window of the plot of log (J(t)) vs. log(t), where J(t) is creep compliance and t is creep time. If the slope of the linear regression is greater than 0.97, steady state is considered to be reached, then the creep test is stopped. In all cases in this study the slope meets the criterion within 2 hours. The steady state shear rate is determined from the slope of the linear regression of all of the data points in the last 10% time window of the plot of ε vs. t, where ε is strain. The zero-shear viscosity is determined from the ratio of the applied stress to the steady state shear rate.

In order to determine if the sample is degraded during the creep test, a small amplitude oscillatory shear test is conducted before and after the creep test on the same specimen from 0.1 to 100 rad/s. The complex viscosity values of the two tests are compared. If the difference of the viscosity values at 0.1 rad/s is greater than 5%, the sample is considered to have degraded during the creep test, and the result is discarded.

### Gel Permeation Chromatography (GPC)

The chromatographic system consisted of a PolymerChar GPC-IR (Valencia, Spain) high temperature GPC chromatograph equipped with an internal IR5 infra-red detector (IR5). The autosampler oven compartment was set at 160° Celsius and the column compartment was set at 150° Celsius. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} \qquad ( EQ 1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{( R {V}_{PeakMax}}{Peak Width at \frac{1}{2} height} )}^{2} \qquad ( EQ 2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( R {V}_{Peak max} - Front Peak {RV}_{one tenth height} )} \qquad ( EQ 3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{polyethyl {ene}_{i}} )} \qquad ( EQ 4 )$$

$${Mw}_{( GPC )} = \frac{{\sum }^{i} ( {IR}_{i} * {M}_{polyethyl {ene}_{i}} )}{{\sum }^{i} {IR}_{i}} \qquad ( EQ 5 )$$

$${Mz}_{( GPC )} = \frac{{\sum }^{i} ( {IR}_{i} * {M}_{polyethyl {ene}_{i}}^{2} )}{{\sum }^{i} ( {IR}_{i} * {M}_{polyethyl {ene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/-0.5% of the nominal flowrate.

$$Flowrate ( effective ) = Flowrate ( nominal ) * ( RV ( FM Calibrated ) / RV ( FM Sample ) ) \qquad ( EQ 7 )$$

### Improved Method for Comonomer Content Analysis (iCCD)

Improved method for comonomer content analysis (iCCD) was developed in 2015 (Cong and Parrott et al., WO2017040127A1). iCCD test was performed with Crystallization Elution Fractionation instrumentation (CEF) (PolymerChar, Spain) equipped with IR-5 detector (PolymerChar, Spain) and two angle light scattering detector Model 2040 (Precision Detectors, currently Agilent Technologies). A guard column packed with 20-27 micron glass (MoSCi Corporation, USA) in a 5 cm or 10 cm (length)×¼″ (ID) stainless was installed just before IR-5 detector in the detector oven. Ortho-dichlorobenzene (ODCB, 99% anhydrous grade or technical grade) was used. Silica gel 40 (particle size 0.2˜0.5 mm, catalogue number 10181-3) from EMD Chemicals was obtained (can be used to dry ODCB solvent before). The CEF instrument is equipped with an autosampler with N2 purging capability. ODCB is sparged with dried nitrogen (N2) for one hour before use. Sample preparation was done with autosampler at 4 mg/ml (unless otherwise specified) under shaking at 160° C. for 1 hour. The injection volume was 300 μl. The temperature profile of iCCD was: crystallization at 3° C./min from 105° C. to 30° C., the thermal equilibrium at 30° C. for 2 minute (including Soluble Fraction Elution Time being set as 2 minutes), elution at 3° C./min from 30° C. to 140° C. The flow rate during crystallization is 0.0 ml/min. The flow rate during elution is 0.50 ml/min. The data was collected at one data point/second.

The iCCD column was packed with gold coated nickel particles (Bright 7GNM8-NiS, Nippon Chemical Industrial Co.) in a 15 cm (length)×¼″ (ID) stainless tubing. The column packing and conditioning were with a slurry method according to the reference (Cong, R.; Parrott, A.; Hollis, C.; Cheatham, M. WO2017040127A1). The final pressure with TCB slurry packing was 150 Bars.

Column temperature calibration was performed by using a mixture of the Reference Material Linear homopolymer polyethylene (having zero comonomer content, Melt index (I₂) of 1.0, polydispersity M_{w}/Mₙ approximately 2.6 by conventional gel permeation chromatography, 1.0 mg/ml) and Eicosane (2 mg/ml) in ODCB. iCCD temperature calibration consisted of four steps: (1) Calculating the delay volume defined as the temperature offset between the measured peak elution temperature of Eicosane minus 30.00° C.; (2) Subtracting the temperature offset of the elution temperature from iCCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference had a peak temperature at 101.0° C., and Eicosane had a peak temperature of 30.0° C.; (4) For the soluble fraction measured isothermally at 30° C., the elution temperature below 30.0° C. is extrapolated linearly by using the elution heating rate of 3° C./min according to the reference (Cerk and Cong et al., U.S. Pat. No. 9,688,795).

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000). All of these reference materials were analyzed same way as specified previously at 4 mg/mL. The reported elution peak temperatures were linearly fit to the linear equation y=−6.3515x.+101.00, where y represented elution temperature of iCCD and x represented the octene mole %, and R² was 0.978.

Molecular weight of polymer and the molecular weight of the polymer fractions was determined directly from LS detector (90 degree angle) and concentration detector (IR-5) according Rayleigh-Gans-Debys approximation (Striegel and Yau, Modern Size Exclusion Liquid Chromatogram, Page 242 and Page 263) by assuming the form factor of 1 and all the virial coefficients equal to zero. Integration windows are set to integrate all the chromatograms in the elution temperature (temperature calibration is specified above) range from 23.0 to 120° C.

The calculation of Molecular Weight (Mw) from iCCD includes the following four steps:
(1) Measuring the interdetector offset. The offset is defined as the geometric volume offset between LS with respect to concentration detector. It is calculated as the difference in the elution volume (mL) of polymer peak between concentration detector and LS chromatograms. It is converted to the temperature offset by using elution thermal rate and elution flow rate. A linear high density polyethylene (having zero comonomer content, Melt index (I₂) of 1.0, polydispersity M_{w}/Mₙ approximately 2.6 by conventional gel permeation chromatography) is used. Same experimental conditions as the normal iCCD method above are used except the following parameters: crystallization at 10° C./min from 140° C. to 137° C., the thermal equilibrium at 137° C. for 1 minute as Soluble Fraction Elution Time, soluble fraction (SF) time of 7 minutes, elution at 3° C./min from 137° C. to 142° C. The flow rate during crystallization is 0.0 ml/min. The flow rate during elution is 0.80 ml/min. Sample concentration is 1.0 mg/ml.
(2) Each LS datapoint in LS chromatogram is shifted to correct for the interdetector offset before integration.
(3) Baseline subtracted LS and concentration chromatograms are integrated for the whole eluting temperature range of the Step (1). The MW detector constant is calculated by using a known MW HDPE sample in the range of 100,000 to 140,000Mw and the area ratio of the LS and concentration integrated signals.
(4) Mw of the polymer was calculated by using the ratio of integrated light scattering detector (90 degree angle) to the concentration detector and using the MW detector constant.

Calculation of half width is defined as the temperature difference between the front temperature and the rear temperature at the half of the maximum peak height, the front temperature at the half of the maximum peak is searched forward from 35.0° C., while the rear temperature at the half of the maximum peak is searched backward from 119.0° C.

### Zero-Shear Viscosity Ratio (ZSVR)

ZSVR is defined as the ratio of the zero-shear viscosity (ZSV) of the branched polyethylene material to the ZSV of the linear polyethylene material at the equivalent weight average molecular weight (Mw-gpc) according to the following Equations (EQ) 8 and 9:

$$ZSVR = \frac{{η}_{0 B}}{{η}_{0 L}} \qquad ( EQ 8 )$$

$${η}_{0 L} = 2.29 \times 1 {0}^{- 15} {M}_{w - gpc}^{3.65} \qquad ( EQ 9 )$$

The ZSV value is obtained from creep test at 190° C. via the method described above. The Mw-gpc value is determined by the conventional GPC method (Equation 5 in the Conventional GPC method description). The correlation between ZSV of linear polyethylene and its Mw-gpc was established based on a series of linear polyethylene reference materials. A description for the ZSV-Mw relationship can be found in the ANTEC proceeding: Karjala, Teresa P., Sammler, Robert L., Mangnus, Marc A., Hazlitt, Lonnie G., Johnson, Mark S., Hagen, Charles M. Jr., Huang, Joe W. L., Reichek, Kenneth N., “Detection of low levels of long-chain branching in polyolefins”, Annual Technical Conference—Society of Plastics Engineers (2008), 66th 887-891.

### Dynamic Rheological Analysis

To characterize the rheological behavior of substantially linear ethylene polymers, S Lai and G. W. Knight introduced (ANTEC '93 Proceedings, Insite™ Technology Polyolefins (ITP)-New Rules in the Structure/Rheology Relationship of Ethylene &-01efin Copolymers, New Orleans, La., May 1993) a new rheological measurement, the Dow Rheology Index (DRI) which expresses a polymer's “normalized relaxation time as the result of long chain branching”. S. Lai et al; (ANTEC '94, Dow Rheology Index (DRI) for Insite™ Technology Polyolefins (ITP): Unique structure-Processing Relationships, pp. 1814-1815) defined the DRI as the extent to which the rheology of ethylene-octene copolymers known as ITP (Dow's Insite Technology Polyolefins) incorporating long chain branches into the polymer backbone deviates from the rheology of the conventional linear homogeneous polyolefins that are reported to have no Long Chain Branches (LCB) by the following normalized equation:

$$DRI = [ 3 \; 650000 \times ( {τ}_{0} / {η}_{0} ) - 1 ] / 10 \qquad ( EQ 10 )$$

wherein τ0 is the characteristic relaxation time of the material and is the zero shear rate complex viscosity of the material. The DRI is calculated by least squares fit of the rheological curve (dynamic complex viscosity η*(ω) versus applied frequency (ω) e.g., 0.01-100 rads/s) as described in U.S. Pat. No. 6,114,486 with the following generalized Cross equation, i.e.

$${η}^{*} ( ω ) = {η}_{0} / [ 1 + {( ω \cdot {τ}_{0} )}^{n} ] \qquad ( EQ 11 )$$

wherein n is the power law index of the material, η*(ω) and ω are the measured complex viscosity and applied frequency data respectively.

Dynamic rheological measurements are carried out, according to ASTM D4440, on a dynamic rheometer (e.g., ARES rheometer by TA Instruments) with 25 mm diameter parallel plates in a dynamic mode under an inert atmosphere. For all experiments, the rheometer has been thermally stable at 190° C. for at least 30 minutes before inserting the appropriately stabilized (with anti-oxidant additives), compression-moulded sample onto the parallel plates. The plates are then closed with a positive normal force registered on the meter to ensure good contact. After about 5 minutes at 190° C., the plates are lightly compressed and the surplus polymer at the circumference of the plates is trimmed. A further 10 minutes is allowed for thermal stability and for the normal force to decrease back to zero. That is, all measurements are carried out after the samples have been equilibrated at 190° C. for about 15 minutes and are run under full nitrogen blanketing.

Two strain sweep (SS) experiments are initially carried out at 190° C. to determine the linear viscoelastic strain that would generate a torque signal which is greater than 10% of the lower scale of the transducer, over the full frequency (e.g. 0.01 to 100 rad/s) range. The first SS experiment is carried out with a low applied frequency of 0.1 rad/s. This test is used to determine the sensitivity of the torque at low frequency. The second SS experiment is carried out with a high applied frequency of 100 rad/s. This is to ensure that the selected applied strain is well within the linear viscoelastic region of the polymer so that the oscillatory rheological measurements do not induce structural changes to the polymer during testing. In addition, a time sweep (TS) experiment is carried out with a low applied frequency of 0.1 rad/s at the selected strain (as determined by the SS experiments) to check the stability of the sample during testing.

The values of storage (or elastic) modulus, loss (or viscous) modulus (G″), complex modulus (G*), complex viscosity (η*) and tan δ (the ratio of loss modulus and storage modulus, G′VG′) were obtained as a function of frequency (ω) at a given temperature (e.g., 190° C.).

### EXAMPLES

### Example 1: Preparation of Polyethylene Compositions 1 and 2

Polyethylene Compositions 1 and 2, which are described according to the one or more embodiments of the detailed description, were prepared by a method and utilizing the catalysts and reactors described below.

All raw materials (monomer and comonomer) and the process solvent (a narrow boiling ranged high-purity isoparaffinic solvent, Isopar-E) were purified with molecular sieves before introduction into the reaction environment. Hydrogen was supplied pressurized as a high purity grade and was not further purified. The reactor monomer feed stream was pressurized via a mechanical compressor to above reaction pressure. The solvent and comonomer feed were pressurized via a pump to above reaction pressure. The individual catalyst components were manually batch diluted with purified solvent and pressured to above reaction pressure. All reaction feed flows were measured with mass flow meters and independently controlled with computer automated valve control systems.

A two reactor system was used in a series configuration. The first reactor was a continuous solution polymerization reactor consisting of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds was possible. The total fresh feed stream to the first reactor (solvent, monomer, comonomer, and hydrogen) was temperature controlled to maintain a single solution phase by passing the feed stream through a heat exchanger. The total fresh feed to the first polymerization reactor was injected into the reactor at two locations with approximately equal reactor volumes between each injection location. The fresh feed was controlled with each injector receiving half of the total fresh feed mass flow. The catalyst components were injected into the polymerization reactor separate from the fresh feeds. The primary catalyst component feed was computer controlled to maintain the reactor monomer conversion at the specified value. The cocatalyst component(s) were fed based on molar ratios to the primary catalyst component or to target a reactor concentration. Immediately following each first reactor feed injection location, the feed streams were mixed with the circulating polymerization reactor contents with static mixing elements. The contents of the first reactor were continuously circulated through heat exchangers responsible for removing much of the heat of reaction and with the temperature of the coolant side responsible for maintaining an isothermal reaction environment at the specified temperature. Circulation around the first reactor loop was provided by a pump.

The second reactor was a continuous solution polymerization reactor consisting of a liquid full, adiabatic, continuously stirred tank reactor (CSTR). Independent control of all fresh solvent, monomer, comonomer, hydrogen, and catalyst component feeds was possible. The total fresh feed stream to the second reactor (solvent, monomer, comonomer, and hydrogen) was temperature controlled to maintain a single solution phase by passing the feed stream through a heat exchanger. The total fresh feed to the second polymerization reactor was injected into the reactor at one location. The catalyst components were injected into the second polymerization reactor separate from the fresh feed. The primary catalyst component feed was computer controlled to maintain the reactor monomer conversion at the specified value. The cocatalyst component(s) were fed based on either the specified molar ratios to the primary catalyst component or to achieve a specified concentration of the cocatalyst component relative to the fresh feed flows to the reactor. Mixing of the second reactor was provided by an agitator. The effluent from the first polymerization reactor (containing solvent, monomer, comonomer, hydrogen, catalyst components, and polymer) exits the first reactor loop and was added to the second reactor separate from the fresh feed and separate from the catalyst feed components.

The second reactor effluent entered a zone where it was deactivated with the addition of and reaction with a suitable reagent (water). Antioxident addition could also occur at this same addition point. Following catalyst deactivation and additive addition, the reactor effluent entered a devolatization system where the polymer was removed from the non-polymer stream. The isolated polymer melt was pelletized and collected. The non-polymer stream passed through various pieces of equipment, which separated most of the ethylene that was removed from the system. Most of the solvent and unreacted comonomer was recycled back to the reactor after passing through a purification system. A small amount of solvent and comonomer was purged from the process.

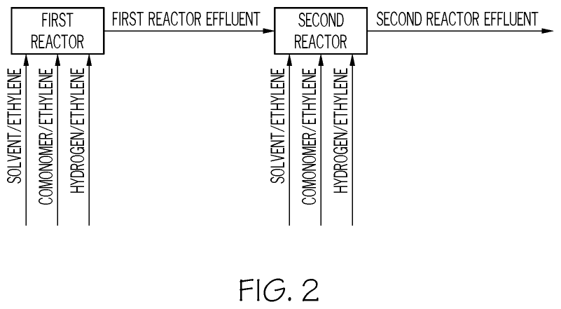

The reactor stream feed data flows that correspond to the values in Table 1 used to produce the example are graphically described in FIG. 2. The data are presented such that the complexity of the solvent recycle system is accounted for and the reaction system can be treated more simply as a once through flow diagram. Table 2 shows the catalyst components referenced in Table 1.

TABLE 1
Polymerization Conditions of Polyethylene Compositions 1 and 2.

| Polyethylene | | Polyethylene | Polyethylene |
|---|---|---|---|
| Composition | | Composition 1 | Composition 2 |
| Reactor Configuration | Type | Dual Series | Dual Series |
| Comonomer type | Type | 1-octene | 1-octene |
| First Reactor Feed | g/g | 6.18 | 6.13 |
| Solvent/Ethylene | | | |
| Mass Flow Ratio | | | |
| First Reactor Feed | g/g | 0.219 | 0.266 |
| Comonomer/Ethylene | | | |
| Mass Flow Ratio | | | |
| First Reactor Feed | g/g | 9.41E−05 | 7.36E−05 |
| Hydrogen/Ethylene | | | |
| Mass Flow Ratio | | | |
| First Reactor | ° C. | 175 | 175 |
| Temperature | | | |
| First Reactor Pressure | barg | 38 | 38 |
| First Reactor Ethylene | % | 90.0 | 89.9 |
| Conversion | | | |
| First Reactor Primary | Type | Catalyst | Catalyst |
| Catalyst Type | | component A | component A |
| First Reactor | Type | Cocatalyst E | Cocatalyst E |
| Cocatalyst 1 Type | | | |
| First Reactor | Type | Cocatalyst D | Cocatalyst D |
| Cocatalyst 2 Type | | | |
| First Reactor | ppm | 6.1 | 6.1 |
| Co-Catalyst 1 Feed | | | |
| Concentration | | | |
| Relative to the Fresh | | | |
| First Reactor Feed | | | |
| First Reactor | ppm | 0.92 | 0.92 |
| Co-Catalyst 2 Feed | | | |
| Concentration | | | |
| Relative to the Fresh | | | |
| First Reactor Feed | | | |
| First Reactor | min | 15.1 | 15.2 |
| Residence Time | | | |
| Percentage of | wt % | 53.1 | 53.1 |
| Total Ethylene | | | |
| Feed to | | | |
| First Reactor | | | |
| Second Reactor Feed | g/g | 3.65 | 3.64 |
| Solvent/Ethylene | | | |
| Mass Flow Ratio | | | |
| Second Reactor Feed | g/g | 0.054 | 0.061 |
| Comonomer/Ethylene | | | |
| Mass Flow Ratio | | | |
| Second Reactor Feed | g/g | 9.92E−04 | 1.85E−03 |
| Hydrogen/ Ethylene | | | |
| Mass Flow Ratio | | | |
| Second Reactor | ° C. | 208 | 210 |
| Temperature | | | |
| Second Reactor | barg | 38 | 37 |
| Pressure | | | |
| Second Reactor | % | 84.4 | 84.2 |
| Ethylene Conversion | | | |
| Second Reactor | Type | Catalyst | Catalyst |
| Primary Catalyst Type | | component B | component B |
| Second Reactor | Type | Cocatalyst C | Cocatalyst C |
| Co-Catalyst 1 Type | | | |
| Second Reactor | Type | Cocatalyst D | Cocatalyst D |
| Co-Catalyst 2 Type | | | |
| Second Reactor | mol/mol | 18 | 18 |
| Cocatalyst 1 to | | | |
| Catalyst Molar Ratio | | | |
| (B to Zr ratio) | | | |
| Second Reactor | ppm | 2.0 | 2.0 |
| Co-Catalyst 2 Feed | | | |
| Concentration | | | |
| Relative to the Fresh | | | |
| Second Reactor Feed | | | |
| Second Reactor | min | 9.2 | 9.2 |
| Residence Time | | | |

TABLE 2
Catalyst Components and Cocatalysts Used to Produce Polyethylene Compositions
1 and 2.

| | |
|---|---|
| Catalyst component A | 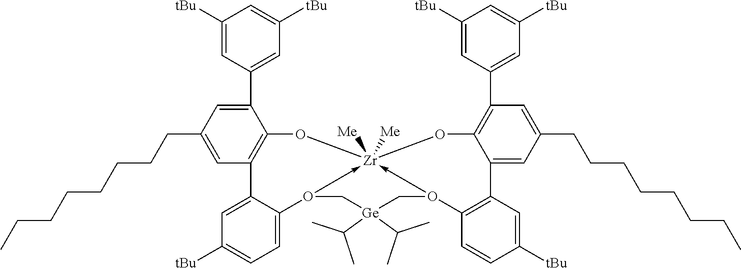 |
| Catalyst component B | 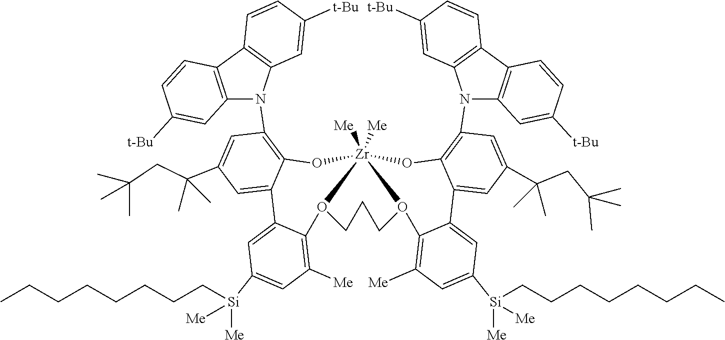 |
| Cocatalyst C | bis(hydrogenated tallow alkyl)methylammonium tetrakis(pentafluoro |
| | phenyl)borate |
| Cocatalyst D | hydrocarbyl-modified methylaluminoxane* |
| Cocatalyst E | bis(hydrogenated tallow alkyl)methylamine |

*Modified with n-octyl substituents such that the methyl:n-octyl ratio is approximately 6:1 and containing 10-20% trialkyl aluminum species

### Example 2: Comparative Polyethylene Compositions A-L

Comparative Compositions A-C were prepared by methods described herein below. Comparative Compositions D-F are bimodal polyethylene compositions that are generally prepared using the catalyst system and processes provided for preparing the Inventive First Compositions in PCT Publication No. WO 2015/200743. Comparative Compositions G-J are commercially available polyethylene compositions. Table 3 identifies the commercially available polyethylene compositions of Comparative Compositions G-J.

TABLE 3
Commercially-Available Comparative Polyethylene Compositions.

| Sample Comparative | Commercial Name |
|---|---|
| Polyethylene Composition | (Company of Manufacture) |
| G | ELITE 5400G (Dow Chemical Co.) |
| H | ELITE 5111G (Dow Chemical Co.) |
| I | EXCEED 1012 (ExxonMobil) |
| J | EXCEED 1018 (ExxonMobil) |

The preparation of Comparative Compositions A-C are described as follows. All raw materials (monomer and comonomer) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressured to above reaction pressure. All reaction feed flows are measured with mass flow meters and independently controlled with computer automated valve control systems.

A two reactor system is used in a series configuration. Each continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to each reactor (solvent, monomer, comonomer, and hydrogen) is temperature controlled to maintain a single solution phase by passing the feed stream through a heat exchanger. The total fresh feed to each polymerization reactor is injected into the reactor at two locations with approximately equal reactor volumes between each injection location. The fresh feed is controlled with each injector receiving half of the total fresh feed mass flow. The catalyst components are injected into the polymerization reactor through injection stingers. The primary catalyst component feed is computer controlled to maintain each reactor monomer conversion at the specified targets. The cocatalyst components are fed based on calculated specified molar ratios to the primary catalyst component. Immediately following each reactor feed injection location, the feed streams are mixed with the circulating polymerization reactor contents with static mixing elements. The contents of each reactor are continuously circulated through heat exchangers responsible for removing much of the heat of reaction and with the temperature of the coolant side responsible for maintaining an isothermal reaction environment at the specified temperature. Circulation around each reactor loop is provided by a pump.

In dual series reactor configuration the effluent from the first polymerization reactor (containing solvent, monomer, comonomer, hydrogen, catalyst components, and polymer) exits the first reactor loop and is added to the second reactor loop.

The second reactor effluent enters a zone where it is deactivated with the addition of and reaction with a suitable reagent (water). At this same reactor exit location other additives are added for polymer stabilization (typical antioxidants suitable for stabilization during extrusion and film fabrication like Octadecyl 3,5-Di-Tert-Butyl-4-Hydroxyhydrocinnamate, Tetrakis(Methylene(3,5-Di-Tert-Butyl-4-Hydroxyhydrocinnamate))Methane, and Tris(2,4-Di-Tert-Butyl-Phenyl) Phosphite).

Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process.

The reactor stream feed data flows correspond to the values in Table 4. The data are presented such that the complexity of the solvent recycle system is accounted for and the reaction system can be treated more simply as a once through flow diagram. Table 6 shows the catalysts and cocatalysts shown in Table 4

TABLE 4

| | | Com- | Com- | Com- |
|---|---|---|---|---|
| | | parative | parative | parative |
| | | Com- | Com- | Com- |
| Polyethylene | | position | position | position |
| Composition | | A | B | C |
| Reactor | Type | Dual | Dual | Dual |
| Configuration | | Series | Series | Series |
| Comonomer type | Type | 1-octene | 1-octene | 1-octene |
| First Reactor Feed | g/g | 5.5 | 5.1 | 5.3 |
| Solvent/Ethylene | | | | |
| Mass Flow Ratio | | | | |
| First Reactor Feed | g/g | 0.22 | 0.39 | 0.36 |
| Comonomer/Ethylene | | | | |
| Mass Flow Ratio | | | | |
| First Reactor Feed | g/g | 1.8E−04 | 1.0E−04 | 9.2E−05 |
| Hydrogen/Ethylene | | | | |
| Mass Flow Ratio | | | | |
| First Reactor | ° C. | 160 | 160 | 160 |
| Temperature | | | | |
| First Reactor | barg | 50 | 50 | 50 |
| Pressure | | | | |
| First Reactor | % | 90.9 | 88.4 | 90.8 |
| Ethylene Conversion | | | | |
| First Reactor | Type | Catalyst | Catalyst | Catalyst |
| Catalyst Type | | component | component | component |
| | | 3 | 1 | 1 |
| First Reactor | Type | Cocatalyst | Cocatalyst | Cocatalyst |
| Cocatalyst 1 Type | | 1 | 1 | 1 |
| First Reactor | Type | Cocatalyst | Cocatalyst | Cocatalyst |
| Cocatalyst 2 Type | | 2 | 2 | 2 |
| First Reactor | Type | Hf | Zr | Zr |
| Catalyst Metal | | | | |
| First Reactor | Ratio | 12.1 | 1.2 | 1.2 |
| Cocatalyst 1 to | | | | |
| Catalyst Molar Ratio | | | | |
| (B to Metal ratio) | | | | |
| First Reactor | Ratio | 50.1 | 15.0 | 9.6 |
| Cocatalyst 2 to | | | | |
| Catalyst Molar Ratio | | | | |
| (Al to Metal ratio) | | | | |
| First Reactor | min | 17.4 | 7.6 | 8.0 |
| Residence Time | | | | |
| Second Reactor Feed | g/g | 2.2 | 2.5 | 2.5 |
| Solvent/Ethylene | | | | |
| Mass Flow Ratio | | | | |
| Second Reactor Feed | g/g | 0.030 | 0.105 | 0.084 |
| Comonomer/Ethylene | | | | |
| Mass Flow Ratio | | | | |
| Second Reactor Feed | g/g | 1.4E−04 | 2.5E−04 | 2.5E−04 |
| Hydrogen/Ethylene | | | | |
| Mass Flow Ratio | | | | |
| Second Reactor | ° C. | 195 | 190 | 190 |
| Temperature | | | | |
| Second Reactor | barg | 52 | 51 | 51 |
| Pressure | | | | |
| Second Reactor | % | 89.1 | 82.9 | 83.7 |
| Ethylene Conversion | | | | |
| Second Reactor | Type | Catalyst | Catalyst | Catalyst |
| | | component | component | component |
| Catalyst Type | | 4 | 2 | 2 |
| Second Reactor | Type | None | Cocatalyst | Cocatalyst |
| Cocatalyst 1 Type | | | 1 | 1 |
| Second Reactor | Type | Cocatalyst | Cocatalyst | Cocatalyst |
| Cocatalyst 2 Type | | 3 | 2 | 2 |
| Second Reactor | Type | Ti | Zr | Zr |
| Catalyst Metal | | | | |
| Second Reactor | mol/mol | n/a | 1.2 | 1.2 |
| Cocatalyst 1 to | | | | |
| Catalyst Molar | | | | |
| Ratio | | | | |
| (B to Metal ratio) | | | | |
| Second Reactor | mol/mol | 4.0 | 3950 | 3520 |
| Cocatalyst 2 to | | | | |
| Catalyst Molar | | | | |
| Ratio | | | | |
| (Al to Metal ratio) | | | | |
| Second Reactor | min | 7.7 | 5.8 | 5.8 |
| Residence Time | | | | |

Comparative Polyethylene Compositions K-L were prepared by a method and utilizing the catalysts and reactors described below.

All raw materials (monomer and comonomer) and the process solvent (a narrow boiling range high-purity isoparaffinic solvent, Isopar-E) were purified with molecular sieves before introduction into the reaction environment. Hydrogen was supplied pressurized as a high purity grade and was not further purified. The reactor monomer feed stream was pressurized via a mechanical compressor to above reaction pressure. The solvent and comonomer feed was pressurized via a pump to above reaction pressure. The individual catalyst components were manually batch diluted with purified solvent and pressured to above reaction pressure. All reaction feed flows were measured with mass flow meters and independently controlled with computer automated valve control systems.

A two reactor system was used in a series configuration. Each continuous solution polymerization reactor consisted of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds was possible. The total fresh feed stream to each reactor (solvent, monomer, comonomer, and hydrogen) was temperature controlled to maintain a single solution phase by passing the feed stream through a heat exchanger. The total fresh feed to each polymerization reactor was injected into the reactor at two locations with approximately equal reactor volumes between each injection location. The fresh feed was controlled with each injector receiving half of the total fresh feed mass flow. The catalyst components were injected into the polymerization reactor through injection stingers. The primary catalyst component feed was computer controlled to maintain each reactor monomer conversion at the specified targets. The cocatalyst components were fed based on calculated specified molar ratios to the primary catalyst component. Immediately following each reactor feed injection location, the feed streams were mixed with the circulating polymerization reactor contents with static mixing elements. The contents of each reactor were continuously circulated through heat exchangers responsible for removing much of the heat of reaction and with the temperature of the coolant side responsible for maintaining an isothermal reaction environment at the specified temperature. Circulation around each reactor loop was provided by a pump.

In the dual series reactor configuration, the effluent from the first polymerization reactor (containing solvent, monomer, comonomer, hydrogen, catalyst components, and polymer) exited the first reactor loop and was added to the second reactor loop.

The second reactor effluent entered a zone where it is deactivated with the addition of and reaction with a suitable reagent (water). At this same reactor exit location other additives were added for polymer stabilization (typical antioxidants suitable for stabilization during extrusion and film fabrication like Octadecyl 3,5-Di-Tert-Butyl-4-Hydroxyhydrocinnamate, Tetrakis(Methylene(3,5-Di-Tert-Butyl-4-Hydroxyhydrocinnamate))Methane, and Tris(2,4-Di-Tert-Butyl-Phenyl) Phosphite).

Following catalyst deactivation and additive addition, the reactor effluent entered a devolatization system where the polymer is removed from the non-polymer stream. The isolated polymer melt was pelletized and collected. The non-polymer stream passes through various pieces of equipment which separate most of the ethylene which is removed from the system. Most of the solvent and unreacted comonomer was recycled back to the reactor after passing through a purification system. A small amount of solvent and comonomer was purged from the process.

The reactor stream feed data are in Table 5. The data are presented such that the complexity of the solvent recycle system was accounted for and the reaction system could be treated more simply as a once through flow diagram. Table 6 shows the catalyst components referenced in Table 5.

TABLE 5
Polymerization Conditions of Comparative Polyethylene Compositions K-L.

| | | Comparative PE | Comparative PE |
|---|---|---|---|
| Polyethylene Composition | | Composition K | Composition L |
| Reactor Configuration | Type | Dual Series | Dual Series |
| Comonomer type | Type | 1-octene | 1-octene |
| First Reactor Feed Solvent/ | g/g | 5.3 | 6.6 |
| Ethylene Mass Flow Ratio | | | |
| First Reactor Feed Comonomer/ | g/g | 0.31 | 0.32 |
| Ethylene Mass Flow Ratio | | | |
| First Reactor Feed Hydrogen/ | g/g | 6.3E−05 | 6.2E−05 |
| Ethylene Mass Flow Ratio | | | |
| First Reactor Temperature | ° C. | 175 | 170 |
| First Reactor Pressure | barg | 50 | 50 |
| First Reactor Ethylene Conversion | % | 91.0 | 91.0 |
| First Reactor Catalyst Type | Type | Catalyst Component 1 | Catalyst Component 1 |
| First Reactor Cocatalyst 1 Type | Type | Cocatalyst 1 | Cocatalyst 1 |
| First Reactor Cocatalyst 2 Type | Type | Cocatalyst 2 | Cocatalyst 2 |
| First Reactor Catalyst Metal | Type | Zr | Zr |
| First Reactor Cocatalyst 1 to | Ratio | 1.1 | 1.2 |
| Catalyst Molar Ratio (B to Zr ratio) | | | |
| First Reactor Cocatalyst 2 to | Ratio | 55.0 | 45.0 |
| Catalyst Molar Ratio (Al to Zr ratio) | | | |
| First Reactor Residence Time | min | 8.5 | 9.0 |
| Second Reactor Feed Solvent/ | g/g | 2.1 | 2.5 |
| Ethylene Mass Flow Ratio | | | |
| Second Reactor Feed Comonomer/ | g/g | 0.068 | 0.063 |
| Ethylene Mass Flow Ratio | | | |
| Second Reactor Feed Hydrogen/ | g/g | 1.1E−03 | 3.1E−04 |
| Ethylene Mass Flow Ratio | | | |
| Second Reactor Temperature | ° C. | 200 | 200 |
| Second Reactor Pressure | barg | 50 | 50 |
| Second Reactor Ethylene | % | 74.2 | 88.0 |
| Conversion | | | |
| Second Reactor Catalyst Type | Type | Catalyst Component 2 | Catalyst Component 2 |
| Second Reactor Cocatalyst 1 Type | Type | Cocatalyst 1 | Cocatalyst 1 |
| Second Reactor Cocatalyst 2 Type | Type | Cocatalyst 2 | Cocatalyst 2 |
| Second Reactor Catalyst Metal | Type | Zr | Zr |
| Second Reactor Cocatalyst 1 to | mol/ | 10.0 | 6.7 |
| Catalyst Molar Ratio (B to Metal | mol | | |
| ratio) | | | |
| Second Reactor Cocatalyst 2 to | mol/ | >100.0 | >100.0 |
| Catalyst Molar Ratio (Al to Metal | mol | | |
| ratio) | | | |
| Second Reactor Residence Time | min | 5.7 | 5.4 |

TABLE 6
Catalyst Components used in the synthesis of Comparative
Compositions A-C and K-L.

| Catalyst | Zirconium, dimethyl[[2,2′′′-[[bis[1- |
|---|---|
| component | methylethyl)germylene]bis(methyleneoxy-kO)]bis[3″,5,5″- |
| 1 (V) | tris(1,1-dimethylethyl)-5′-octyl[1,1′:3′,1″-terphenyl]-2′- |
| | olato-kO]](2-)] |
| Catalyst | Zirconium, dimethyl [[2,2′′′-[1,3-propanediylbis(oxy- |
| component | kO)]bis[3-[2,7-bis(1,1-dimethylethyl)-9H-carbazol-9-yl]]- |
| 2 (VI) | 5′-(dimethyloctylsilyl)-3′-methyl-5-(1,1,3,3- |
| | tetramethylbutyl)[1,1]-biphenyl]-2-olato-kO]](2-)] |
| Catalyst | Hafnium,″[2′,2′′′-[1,2-cyclohexanediylbis |
| component | (methyleneoxy″-.″kappa.O)]bis[3-(9H-carbazol-9-yl)-5- |
| 3 | methyl[1,1′-bipheny1]-2-olato″-.kappa.O]](2-)]dimethyl- |
| Catalyst | This heterogeneous Ziegler-Natta type catalyst-premix was |
| component | prepared substantially according to U.S. Pat. No. 4,612,300, |
| 4 | by sequentially adding to a volume of ISOPAR E, a slurry |
| | of anhydrous magnesium chloride in ISOPAR E, a solution |
| | of EtAlCl2 in heptane, and a solution of Ti(O-iPr)4 in |
| | heptane, to yield a composition containing a magnesium |
| | concentration of 0.20M and a ratio of Mg/Al/Ti of |
| | 40/12.5/3. An aliquot of this composition was further |
| | diluted with ISOPAR E to yield a final concentration of 500 |
| | ppm Ti in the slurry. An aliquot of this composition can be |
| | further diluted with ISOPAR E if required. While being fed |
| | to, and prior to entry into the polymerization reactor, the |
| | catalyst premix was contacted with a dilute solution of |
| | Et3Al, in the molar Al to Ti ratio specified in the data table |
| | to give the active catalyst. |
| Cocatalyst | bis(hydrogenated tallow alkyl)methylammonium |
| 1 | tetrakis(pentafluorophenyl) borate |
| Cocatalyst | modified methyl aluminoxane |
| 2 | |
| Cocatalyst | Tri-ethyl aluminum |
| 3 | |

### Example 3: Analysis of Polyethylene Compositions 1-2 and Comparative Polyethylene Compositions A-L

Polyethylene Compositions 1-2 of Example 1 and Comparative Polyethylene Compositions A-L of Example 2 were analyzed by iCCD. Additional data generated from the iCCD testing of all samples are provided in Tables 7 and 8. Specifically, Tables 7 and 8 include analysis of the iCCD data, including the areas of the respective first and second polyethylene fractions (45-90° C. and 90-120° C.). Additional data are also provided for each example composition including overall density, Dart strength (method A), melt index, weight average molecular weight in the second PE fraction. These properties are based on monolayer blown films consisting completely of each polyethylene sample.

To conduct dart testing as well as other testing based on formed films, 2 mil blown films were formed with the polyethylene samples. Specifically, monolayer blown films are produced via an Egan Davis Standard extruder, equipped with a semi grooved barrel of ID 3.5 inch; 30/1 L/D ratio; a barrier screw; and an Alpine air ring. The extrusion line has an 8 inch die with internal bubble cooling. The extrusion line also has a film thickness gauge scanner. The film fabrication conditions were: film thickness maintained at 2 mil (0.001 in or 0.0254 mm); blow up ratio (BUR) 2.5; die gap 70 mil; and frost line height (FLH) 37 inch. The output rate was constant at 260 lbs/hr.

TABLE 7
Comparison of Polyethylene Compositions 1-2 and
Comparative Polyethylene Compositions A-L.

| | | | | | Ratio of First PE | |
|---|---|---|---|---|---|---|
| | | | First PE | Second PE | fraction area to | |
| PE | Overall | Overall | fraction area | fraction area | Second PE | Trough |
| Sample | density | MI | (45-90° C.) | (90-120° C.) | fraction area | Temp. |
| Unit | (g/cm3) | g/10 min | % | % | | ° C. |
| 1 | 0.928 | 0.84 | 69.18 | 30.41 | 2.28 | 92 |
| 2 | 0.928 | 0.81 | 74.33 | 24.67 | 3.02 | 88 |
| A | 0.919 | 0.81 | 69.55 | 29.81 | 2.33 | 85 |
| B | 0.935 | 0.85 | 34.47 | 65.12 | 0.53 | 84 |
| C | 0.919 | 0.81 | 67.87 | 31.63 | 2.15 | 84 |
| D | 0.912 | 0.85 | 82.5 | 15.68 | 5.26 | 76 |
| E | 0.918 | 0.85 | 68.76 | 30.14 | 2.28 | 75 |
| F | 0.926 | 0.85 | 60.96 | 38.69 | 1.58 | 83 |
| G | 0.916 | 1.00 | 83.94 | 14.86 | 5.65 | 77 |
| H | 0.925 | 0.85 | 57.09 | 42.53 | 1.34 | 82 |
| I | 0.912 | 1.00 | 94.81 | 4.75 | 19.96 | N/A |
| J | 0.918 | 1.00 | 83.83 | 15.76 | 5.32 | N/A |
| K | 0.928 | 0.82 | 61.40 | 37.88 | 1.62 | 84 |
| L | 0.928 | 0.83 | 47.89 | 51.53 | 0.93 | 85 |

TABLE 8
Comparison of Polyethylene Compositions 1-2 and Comparative
Polyethylene Compositions A-L.

| | Mw of | | |
|---|---|---|---|
| PE | second PE | | |
| Sample | fraction | Overall | Dart A |
| Unit | (g/mol) | MWD | g |
| 1 | 56,869 | 4.5 | 972 |
| 2 | 54,814 | 7.4 | 1735 |
| A | 73,154 | 2.7 | 1848 |
| B | 92,618 | 3.7 | 273 |
| C | 66,605 | 2.9 | 2280 |
| D | 111,099 | 3.2 | — |
| E | 88,882 | 3.7 | 1925 |
| F | 77,280 | 3.9 | 1101 |
| G | 122,607 | 3.9 | 1200 |
| H | 95,224 | 3.7 | 400 |
| I | 79,009 | 2.4 | 1800 |
| J | 104,042 | 2.5 | 1200 |
| K | 51,932 | 4.6 | 1800 |
| L | 64,068 | 3.5 | 996 |

As shown in Tables 7 and 8, these results show that none of Comparative Samples A-L exhibited comparable dart strengths at overall densities of at least 0.924 g/cm³ while having a ratio of the first polyethylene fraction area to the second polyethylene fraction area is from 2.0 to 4.0.

It will be apparent that modifications and variations are possible without departing from the scope of the disclosure defined in the appended claims. More specifically, although some aspects of the present disclosure are identified herein as preferred or exemplary or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A polyethylene composition comprising:
a first polyethylene fraction area defined by an area in an elution profile via improved comonomer composition distribution (iCCD) analysis method in a temperature range of 45° C. to 90° C.;
a first peak in the temperature range of 45° C. to 90° C. in the elution profile;
a second polyethylene fraction area defined by an area in the elution profile in a temperature range of 90° C. to 120° C.;
a second peak in the temperature range of 90° C. to 120° C. in the elution profile; and
a local minimum in a temperature range of from 80° C. to 95° C. in the elution profile via iCCD analysis;
wherein the polyethylene composition has a density of 0.924 g/cm³ to 0.936 g/cm³ and a melt index (I₂) of 0.5 g/10 minutes to 1.2 g/10 minutes, and wherein a ratio of the first polyethylene fraction area to the second polyethylene fraction area is from 2.0 to 4.0.

2. The polyethylene composition of claim 1, wherein the polyethylene composition has a molecular weight distribution, expressed as the ratio of the weight average molecular weight to number average molecular weight (Mw/Mn) in the range of from 2.5 to 8.0.

3. The polyethylene composition of claim 1 or 2, wherein the first peak in the temperature range of 45° C. to 90° C. in the elution profile is a first single peak; and wherein the first polyethylene fraction area is an area in the elution profile beneath the first single peak of the first polyethylene fraction from 45° C. to 90° C.

4. The polyethylene composition of any of the preceding claims, wherein the second peak in the temperature range of 90° C. to 120° C. in the elution profile is a second single peak; and wherein the second polyethylene fraction area is an area in the elution profile beneath the second single peak of the second polyethylene fraction from 90° C. to 120° C.

5. The polyethylene composition of any of the preceding claims, wherein the first polyethylene fraction area comprises from 60% to 80% of the total area of the elution profile.

6. The polyethylene composition of any of the preceding claims, wherein the second polyethylene fraction area comprises from 10% to 50% of the total area of the elution profile.

7. The polyethylene composition of any of the preceding claims, wherein the polyethylene composition has a zero shear viscosity ratio of less than 3.0.

8. The polyethylene composition of any of the preceding claims, wherein the width of the single peak of the second polyethylene fraction at 50 percent peak height is less than 10.0° C.

9. The polyethylene composition of any of the preceding claims, wherein the difference between the single peak of the second polyethylene fraction and the single peak of the first polyethylene fraction is at least 10° C.

10. The polyethylene composition of any of the preceding claims, wherein the first polyethylene fraction has a melt index (I₂) of from 0.01 g/10 minutes to 0.18 g/10 minutes.

11. The polyethylene composition of any of the preceding claims, wherein the second polyethylene fraction has a molecular weight of less than 100,000 when measured via improved comonomer composition distribution (iCCD) analysis method.

12. A film comprising the polyethylene composition according to any of the preceding claims.

13. The film of claim 12, wherein the film is a multilayer film.

14. The film of claim 12, wherein the film is a monolayer film.

15. The film of claim 12, wherein the film is a monolayer blown film formed from the polyethylene composition and having a thickness of two mils has a Dart drop impact of at least 1000 grams when measured according to ASTM D1709 Method A.
